(19) United States
(12) Patent Application Publication
(10) Pub. No.: US 2025/0076850 A1
(43) Pub. Date: Mar. 6, 2025

(54) ODOR DIGITALIZATION DATABASES AND REPRODUCTION AND ALTERING SYSTEMS

(71) Applicant: Monell Chemical Senses Center, Philadelphia, PA (US)

(72) Inventors: Joel Mainland, Philadelphia, PA (US); Robert Pellegrino, JR., Philadelphia, PA (US)

(21) Appl. No.: 18/661,262

(22) Filed: May 10, 2024

Related U.S. Application Data
(60) Provisional application No. 63/579,680, filed on Aug. 30, 2023.

(51) Int. Cl. G05B 19/4155

(52) U.S. Cl. CPC G05B 19/4155; G05B 2219/32287

(57) ABSTRACT

A system may include an odor input device configured to input a set of odor characteristics of the odor. An odor characteristic in the set may be a perception of intensity of the odor characteristic. The system may also include a computing device configured to convert the set of odor characteristics to a vector of primary odors. The vector of primary odors defines the odor in an odor gamut. The system may also include a storage device that stores the vector of primary odors as a digital representation of the odor. The system may also include an olfactometer that includes receptacles. Each receptacle stores one of the primary odors. The olfactometer is configured to receive the vector and reproduce the odor using a composition of the primary odors determined based on the vector that corresponds to the digital representation of the odor.

### CROSS-REFERENCE TO RELATED APPLICATION

The present application claims the benefit of U.S. Provisional Patent Application No. 63/579,680, filed on Aug. 30, 2023, which is hereby incorporated by reference in its entirety.

### FEDERALLY SPONSORED RESEARCH AND DEVELOPMENT

This disclosure was made with government support under R01DC017757 and F32DC020380 awarded by the National Institutes of Health. The government may have certain rights in the disclosure.

### BACKGROUND

The characterization and recording of odors represent a longstanding challenge in various industries and scientific fields. Unlike visual or auditory stimuli, odors can be inherently elusive and complex, posing significant difficulties in their precise description and measurement. The subjective nature of olfactory perception, combined with the intricate molecular composition of odorous substances, has rendered traditional methods of odor analysis cumbersome and often inadequate.

Throughout history, humanity's fascination with odors has been evident, evidenced by the extensive literature on fragrances, aromas, and their perceived effects on emotions and behavior. However, attempts to systematically categorize and quantify odors have been impeded by their inherently subjective nature. Individuals may perceive odors differently based on various factors such as genetics, physiological differences, and past experiences. Consequently, establishing a standardized system for odor classification has proven elusive, hindering efforts to digitally record and reproduce odors accurately.

### SUMMARY

In some embodiments, the disclosure described herein relate to a system for altering an odor, the system including: a computing device including memory and one or more processors, the memory configured to store code including instructions, wherein the instructions, when executed by the one or more processors, cause the one or more processors to: receive a characterization of a source odor, the characterization determined according to a set of odor characteristics; initiate an odor gamut that is defined by a plurality of primary odors, each primary odor defined by one or more component compounds; and determine a target release mixture of the primary odors that alters the source odor to a target odor, wherein the target release mixture superimposes with the source odor in the odor gamut to generate the target odor; and an olfactometer in communication with the computing device, the olfactometer configured to release, in an environment where the source odor is present, a chemical mixture corresponding to the target release mixture to convert the source odor to the target odor.

In some embodiments, the disclosure described herein relates to a computer-implemented method for altering an odor, the computer-implemented method includes: receiving a characterization of a source odor, the characterization determined according to a set of odor characteristics; initiating an odor gamut that is defined by a plurality of primary odors, each primary odor defined by one or more component compounds; determining a target release mixture of the primary odors that alters the source odor to a target odor, wherein the target release mixture superimposes with the source odor in the odor gamut to generate the target odor; and transmitting the target release mixture to an olfactometer to cause the olfactometer to release, in an environment where the source odor is present, a chemical mixture corresponding to the target release mixture to convert the source odor to the target odor.

In some embodiments, the disclosure described herein relates to a system for reproducing an odor, the system including: an odor input device configured to input a set of odor characteristics of the odor, an odor characteristic in the set being a perception of the intensity of the odor characteristic; a computing device configured to convert the set of odor characteristics to a vector of primary odors, the vector of primary odors defining the odor in an odor gamut; a storage device including a memory configured to store the vector of primary odors as a digital representation of the odor; and an olfactometer including a plurality of receptacles, wherein each of the receptacles is configured to store one of the primary odors, and wherein the olfactometer is configured to receive the vector and reproduce the odor using a composition of the primary odors determined based on the vector that corresponds to the digital representation of the odor.

In some embodiments, the disclosure described herein relates to a computer-implemented method for reproducing an odor, the computer-implemented method including: receiving a set of odor characteristics of the odor, an odor characteristic in the set being a perception of the intensity of the odor characteristic; converting the set of odor characteristics to a vector of primary odors, the vector of primary odors defining the odor in an odor gamut; storing the vector of primary odors as a digital representation of the odor; transmitting the vector to an olfactometer, the olfactometer including a plurality of receptacles, each of the receptacles configured to store one of the primary odors; and causing an olfactometer to reproduce the odor using a composition of the primary odors determined based on the vector that corresponds to the digital representation of the odor.

In some embodiments, the disclosure described herein relates to an apparatus for generating a target aroma, the apparatus including: a means for inputting a digital representation of the target aroma into a control module, wherein the digital representation is a numerical vector, and each value of the vector corresponds to the perception of intensity of an odor characteristic selected from the following: i. Green ii. Cucumber iii. Herbal iv. Mint v. Woody vi. Pine vii. Floral viii. Powdery ix. Fruity x. Citrus xi. Tropical xii. Berry xiii. Peach xiv. Sweet xv. Caramellic xvi. Vanilla xvii. brown spice xviii. smoky xix. burnt xx. roasted xxi. grainy xxii. meaty xxiii. nutty xxiv. fatty xxv. coconut xxvi. waxy xxvii. dairy xxviii. buttery xxix. cheesy xxx. animal xxxi. sulfurous xxxii. onion/garlic xxxiii. earthy xxxiv. mushroom xxxv. musty xxxvi. medicinal xxxvii. phenolic xxxviii. cooling xxxix. sharp xl. chlorine xli. alcoholic xlii. plastic xliii. rubber xliv. fermented xlv. sour xlvi. rotten/decay xlvii. fecal xlviii. ammonia xlix. fishy 1. ozone 1i. metallic, a set of primary odor sources, each including a container for storing a single odor from the set of primary odors; a device selected from the group consisting of dispersers and collectors; pumping means associated with each of said odor sources for drawing odor source material therefrom and delivering the drawn odor source material to said device; and the control means including a model trained to generate a formula for the subject aroma from a combination of two or more odors from a set of primary odors and being responsive to said means for inputting a digital representation of said target aroma for selecting and operating said pumping means; whereby a combination of primary odor source materials from said primary odor sources, selected by the control module based on the generated formula, and corresponding to the numerical vector, is delivered by said pumping means to said device.

### BRIEF DESCRIPTION OF THE DRAWINGS

FIG. 1 is a block diagram that illustrates an example of a system for storing digitalization of odors, reproducing odors, and/or altering odors, in accordance with some embodiments.

FIG. 2 is a conceptual diagram illustrating a conceptual representation of an example odor gamut, in accordance with some embodiments.

FIG. 3 is a block diagram illustrating an example design of an olfactometer, in accordance with some embodiments.

FIG. 4 is an example sequence diagram illustrating an example series for reproducing an odor, in accordance with some embodiments.

FIG. 5 is an example sequence diagram illustrating an example series for altering an odor, in accordance with some embodiments.

FIG. 6 is a bar chart illustrating an experimental result of using odor gamut to digitalize odors, in accordance with some embodiments.

FIG. 7 is a conceptual diagram illustrating the structure of an example neural network, in accordance with some embodiments.

FIG. 8 is a block diagram illustrating components of an example computing machine, in accordance with some embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Overview

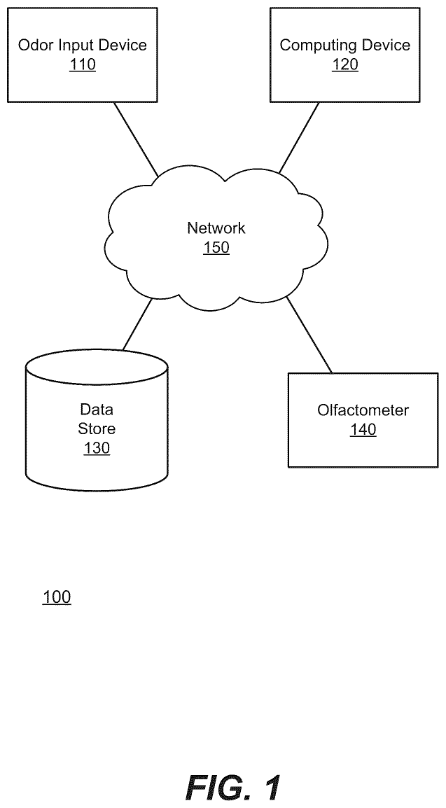

FIG. (FIG. 1 is a block diagram that illustrates an example of a system 100 for storing digitalization of odors, reproducing odors, and/or altering odors, in accordance with some embodiments. By way of example, the system 100 may be a system for digitizing olfaction and may include an odor input device 110, a computing device 120, a data store 130, and an olfactometer 140. The entities and components in the system 100 may communicate with each other with a network 150. In various embodiments, the system 100 may include different, fewer, or additional components.

The components in the system 100 may correspond to separate standalone devices that are in communication with other devices in the system 100 or sub-components of a larger device. Likewise, the components in the system 100 may be geographically located in the same location or distributed in various locations. In some embodiments, the components in the system 100 may be geographically located in the same physical housing, consolidating all functionalities into a single olfaction device that is capable of storing digitalization of odors, reproducing odors, and/or altering odors, thus providing an all-in-one solution for olfaction analysis and odor control. In some embodiments, one or more components in the system 100 may be located geographically near each other but are not part of the sub-components in the same device. For example, an odor input device 110 and a computing device 120 may be different computing devices that are located in the same physical environment and are in communication with each other to capture a digital record of an odor present in the environment. In some embodiments, the components can be distributed across various locations, offering flexibility and scalability. For instance, the odor input device 110 may be a computing and/or sensing device that is physically located in an environment of a source odor. The computing device 120 and the data store 130 may be remote devices that process the digitalization of odors and related data analyses on the Cloud. The computing device 120 may be a device that is used to control odor and is located in another environment where odor is controlled. In various embodiments, other arrangements of locations and distribution of functionalities are also possible.

While each of the components in the system 100 is sometimes described in disclosure in a singular form, the system 100 may include one or more of each of the components. For example, in some embodiments, a computing device 120 may take the form of a Cloud-based computing server that is in communication with multiple odor input devices 110 and olfactometers 140. Such a system may be used to digitally store different kinds of odors and reproduce certain odors in different locations. In some embodiments, there can be multiple computing devices 120, each of which may be used in communication with an odor input device 110 to analyze the odor detected or inputted by the odor input device 110.

In some embodiments, an odor input device 110 is a device that provides an input of the characterization of an odor in an environment. The input may take the form of a manual input by a user in the environment or an automatic input such as for an odor input device 110 that is equipped with odor sensors. The characterization of an odor may take various forms. In some embodiments, the characterization may take the form of a set of odor characteristics. Each odor characteristic may be an intensity of a perception of a familiar odor characteristic. An example list of common odor characteristics is shown in Table 1. In some embodiments, the perception of an odor characteristic may be perceived by a natural person or be measured by an odor sensor. In some embodiments, the characterization may take the form of a vector of primary odors. For example, an odor may be characterized as a composition of different primary odors. Primary odors may be defined under an odor gamut system so that various combinations of primary odors can cover a large variety of odors. In some embodiments, the characterization of an odor may be based on the source, such as by identifying where the odor is coming from or what is causing the odor, such as food, chemicals, plants, or animals. In some embodiments, the characterization of an odor may also take the form of a known familiar odor, such as coffee, banana, pineapple, lavender, vanilla, grass, citrus, campfire smoke, rain, ocean, rotten eggs, sewage, garbage, skunk, mold, feces, urine, etc.

The terms odor, smell, aroma, and the like may be used interchangeably in this disclosure. In some cases, the term odorant may be used to refer to a single molecule, while odor may be used to refer to any composition having a smell. The term target odor, in some embodiments, may be used to refer to an odor that is desirable to reproduce, transmit, etc. The use of the terms odor, smell, aroma, and the like should not be interpreted to limit the recited component to a single molecule or combination unless explicitly specified.

In some embodiments, the characterization of an odor in an environment may take the form of an aggregation of various characterizations inputted by multiple sources. For example, in an environment, there can be multiple users that provide characterizations of an odor in the environment. In another example, there can be one or more users that provide perception of odor characteristics and a set of odor sensors that measure the odor based on chemical receptors. The overall characterization of an odor in the environment may be an aggregation of various inputs that describe the odor. The aggregation may be based on the average perceptions of individuals, an adjustment of an objective measure by sensors based on additional inputs from human perceptions, or another suitable way.

In some embodiments, an odor input device 110 may take the form of a manual input device that receives inputs of odor perceptions from an individual. For example, the odor input device 110 may be a computing device that displays a graphical user interface for a user to input the scales of intensity of odor characteristics. For example, the graphical user interface may provide a selection of a scale (e.g., 0-5) of the user's perception of the intensity of each odor characteristic (e.g., woody=4, fruity=5, smoky=2, and the rest of odor characteristics=0). In some embodiments, the graphical user interface may start with a list of known odors for the user to select. After the user's selection, the graphical user interface may record the known odor as the characterization of the odor in the environment or provide another page of the interface that allows the user to fine-tune the intensity of various odor characteristics. For example, the user may select a familiar fruit odor and the graphical user interface may display a pre-set scale of citrus=3 and berry=5 to the user for the user to further adjust the individual perceived intensity of each odor characteristic.

In some embodiments, an odor input device 110 may take the form of an automatic input device that may include various electronic odor sensors used to measure an odor in an environment. In various embodiments, electronic odor sensors may take different forms such as chemo resistive sensors, conducting polymer sensors, metal oxide sensors, etc. The sensors may detect the signals based on the units measured by the sensors and the characterization of an odor in this situation may take the form that is different from a user's input of perception of intensities of odor characteristics. For example, in some embodiments, the characterization of odor generated by electronic odor sensors may take the form of an array of sensor measurement values in a time series. Other suitable ways of measuring the characterization are also possible.

In some embodiments, an odor input device 110 may take the form of a computing device that is used to predict the odor characteristics of an odor. For example, one or more odor characteristic values may be generated by a computer based on the molecular structure or composition of chemicals associated with the odor.

After the odor input device 110 records a characterization of an odor, the odor input device 110 may transmit the data of the characterization of the odor to a computing device 120 for storage, signal processing, and other analyses.

In some embodiments, a computing device 120 is a device that provides analyses to characterizations of various odors that are input from one or more odor input devices 110. The analyses provided by the computing device 120 may include signal processing, normalization of different characterizations, aggregation of characterizations, storage of characterizations of odors, and digital analyses in changing characterizations of odors. By way of example, if an odor input device 110 is a device that includes odor sensors, the computing device 120 may process the signal data and apply various filtering techniques to process the signal data. In some embodiments, the characterizations of odors may take different formats, and the computing device 120 may perform normalization to convert the characterizations of odors into a standardized format. In some embodiments, the computing device 120 may cause the odor represented in a digital format to be stored in the data store 130 so that the odor may be reproduced or altered in a controlled manner. In some embodiments, the computing device 120 may perform various digital analyses on the odor to predict how the odor may be altered based on the addition of one or more odors or mixtures of chemicals. In some embodiments, the digital analyses may be performed by one or more models that can be ruled-based, heuristics-based, and/or machine-learning-based.

In some embodiments, the computing device 120 may convert characterizations of odors in a standard format that is based on an odor gamut that is defined by a number of primary odors. In some embodiments, an odor gamut may be constructed by a number of primary odors and is intended to cover different variations of odors using the gamut. A particular odor in the gamut may be defined as a combination of one or more primary odors. The combination may be defined as a linear combination of the primary odors or a certain weighted combination of the primary odors. The primary odors may be selected in different suitable ways based on the gamut to be constructed. In some embodiments, the primary odors are determined based on a dataset of various known odors to select the primary odors candidates that can be used as combinations to create the odors in the dataset. By way of example, the known odors in the dataset may each be represented as a vector of intensity of various odor characteristics. In some embodiments, an eigenvalue analysis may be performed to identify eigenvectors that may be considered as most representative of the dataset. The eigenvectors may take the form of vectors of odor characteristics. A primary odor may be constructed based on one of the eigenvectors such as by selecting a combination of compounds that may generate a set of odor characteristics that is close to the values in the eigenvectors. Alternatively, or additionally, in some embodiments, instead of determining eigenvectors, primary odors may each correspond to a primary odorant. By way of example, a set of naturally occurring and known safe odorants may be used as the primary odors. In turn, an odor gamut may be constructed based on the set of odorants. Other suitable ways or any combinations that are disclosed herein, to define primary odors are also possible in different embodiments. In some embodiments, the values in the combination may be determined by a machine learning model that is trained on various training samples of odors that have associated vectors of primary odors according to an odor gamut. The machine learning model may predict the vector of primary odors for a new odor based on the characterization of the new odor.

As an odor gamut is defined, the computing device 120 may convert characterizations of odors to a vector of primary odors. For example, the received data of the odor in an environment may be in a non-standardized format such as a combination of ratings of odor characteristics from a user present in the environment. Each primary odor in an odor gamut may be represented as a vector of odor characteristics. The computing device 120 may determine a combination (e.g., a linear combination) of primary odors that generates the values of the ratings of odor characteristics from the user. The combination of primary odors may be represented as values of a composition of the primary odors. In turn, the computing device 120 may represent the odor in the environment using a vector form of the values of the composition. In some embodiments, the computing device 120 may store the vector as the digital representation of the odor and may assign an identifier to identify the odor. In some embodiments, the received data of the odor in an environment may be in another format such as sensor readings. The computing device 120 may convert the sensor readings into a set of odor characteristics and generate the vector of primary odors based on the set of odor characteristics.

A computing device 120 may also perform computation on the analysis of odors and alteration of odor in a controlled manner. In some embodiments, a source odor (such as a foul smell) may be present in an environment. Based on an odor gamut, the source odor may be combined with another mixture of primary odors to generate a target odor (such as a pleasant or neutral smell). The computing device 120 may initiate the odor gamut and determine the coordinate of the source odor in the gamut. In turn, the computing device 120 may determine another vector that may alter the source odor to the target odor. The computing device 120 may perform operations such as vector operations to determine the vector that represents the composition of primary odors to be added to the environments. Each primary odor may correspond to a composition of one or more chemical compounds. In turn, the computing device 120 may determine the overall composition of the chemical compounds to be released into the environment to alter the source odor. The computing device 120 may cause an olfactometer 140 in the environment to release the composition of the chemical compounds, such as by transmitting the composition data to the olfactometer 140.

In some embodiments, the computing device 120 may train one or more models that could include machine learning models, rule-based models, heuristic models, and/or a combination thereof. The model may be used to analyze odor and to predict a certain digital representation of odor (e.g., a vector of primary odors) would in fact generate a perception of odor that is similar to the digital representation. In some embodiments, a model may be pre-trained and stored in the computing device 120 as part of the functionality of the computing device 120. In some embodiments, the computing device 120 may perform additional training or re-training of the model. In some embodiments, the model may be a machine learning model. The computing device 120 may use machine learning models to perform the functionalities described herein. Example machine learning models include regression models, support vector machines, naïve Bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

A computing device 120 is a computing device that may take various forms in different embodiments. In some embodiments, the computing device 120 may be the computing component of an all-in-one system 100 that includes the odor input device 110, the computing device 120, the data store 130, and the olfactometer 140. In some embodiments, the computing device 120 is a computing device such as a personal computer (PC), a desktop computer, a laptop computer, a tablet computer, a server-based and/or network-linked computer, a smartphone, a wearable electronic device such as a smartwatch, or another suitable electronic device. In some embodiments, the computing device 120 may be a server computer that includes one or more processors and memory that stores code instructions that are executed by one or more processors to perform various processes described herein. In some embodiments, the computing device 120 (despite written in a singular form) may be a pool of computing devices that may be located at the same geographical location (e.g., a server room) or be distributed geographically (e.g., cloud computing, distributed computing, or in a virtual server network). In some embodiments, the computing device 120 may be a collection of servers that independently, cooperatively, and/or distributively provide various products and services described in this disclosure. The computing device 120 may also include one or more virtualization instances such as a container, a virtual machine, a virtual private server, a virtual kernel, or another suitable virtualization instance.

In some embodiments, a data store 130 may serve as a repository for storing odor data, results, and analysis of odor generated by the system 100. For example, various odors that are known in industries (e.g., fragrance companies, chemical companies, food industry) may be represented as digital representations and stored in the data store 130. The digital representations may take the forms of vectors of primary odors, sets of odor characteristics, volume/mass compositions of compounds, or other suitable formats. Odors that are reported to be presented in various environments may also be stored as digital representations in the data store 130. In some embodiments, users may attempt to record certain odors and may use odor input device 110 to report the odor characteristics. In various embodiments, other additional types of data sources may be used to construct a database of digital representations of odors. The data store 130 may form a database that is stored by various odor data instances. The odor data instances may include a set of odor characteristics and/or vectors of primary odors. In some embodiments, the database may include columns as values of primary odors. Each odor data instance may be identified by an identifier and is structured as a row. The columns may be the values of the primary odors or values of odor characteristics. The odor data instances may be sorted and filtered by the values of the primary odors or values of odor characteristics.

The data store 130 includes one or more storage units such as memory that take the form of a non-transitory and non-volatile computer storage medium to store various data. The computer-readable storage medium is a medium that does not include a transitory medium such as a propagating signal or a carrier wave. The data store 130 may be used by the computing device 120 to store odor data related to the computing device 120. In some embodiments, the data store 130 communicates with other components by a network. In some embodiments, data store 130 may be referred to as a Cloud storage server. Examples of cloud storage service providers may include AMAZON AWS, DROPBOX, RACKSPACE CLOUD FILES, AZURE, GOOGLE CLOUD STORAGE, etc. In some embodiments, instead of a cloud storage server, the data store 130 is a storage device that is controlled and connected to the computing device 120. For example, the data store 130 may take the form of memory (e.g., hard drives, flash memory, discs, ROMs, etc.) used by the computing device 120 such as storage devices in a storage server room that is operated by the computing device 120. In some embodiments, the data store 130 may be the storage unit of an all-in-one system 100 that includes an odor input device 110, a computing device 120, a data store 130, and an olfactometer 140.

An olfactometer 140 may be a physical odor delivery device that includes one or more chemicals that are used to create an odor based on a digital representation of the odor. In some embodiments, the olfactometer 140 may include a number of receptacles that store chemicals in one or more suitable forms such as liquid solutions, pressurized vapor, powders, etc. The olfactometer 140 may also include a number of controls. Each control may correspond to a receptacle and is used to control the release of chemicals in the receptacle. The controls may take any suitable forms such as switches, valves, pumps, heaters for vaporization of solutions, mechanical actuators, and any combinations thereof. The control of the composition of chemicals to be released into an environment may be performed based on concentration, volume, pressure, mass, temperature, and other metrics. In some embodiments, the olfactometer 140 may include a mixing chamber for the composition to be mixed before the composition is released. In some embodiments, the olfactometer 140 may include a control element such as a processor that directs the controls to regulate the composition to be released. The processor may receive various digital representations of the odors, such as a vector of primary odors or a volume/mass composition of the chemicals. The processor may convert the digital representation that a format that is used to direct the controls to regulate the composition. In some embodiments, the olfactometer 140 may also include a control interface such as a graphical user interface for a user to control the release of an odor. For example, the user may manually enter a set of odor characteristics or may specify a known odor. The processor of the olfactometer 140 may determine the vector of primary odors corresponding to the user input and release a chemical mixture to produce the odor.

The communications among an odor input device 110, a computing device 120, a data store 130, and an olfactometer 140 may be transmitted via a network 150. While in FIG. 1 the network 150 is depicted as a cloud network, a network 150 may also be a local network or circuit connection within a device, such as in the situation where the system 100 is an all-in-one device. In some embodiments, a network 150 may also be a local wireless network. In some embodiments, a network 150 may be a public network such as the Internet. In some embodiments, a network 150 uses standard communications technologies and/or protocols. For example, the network 150 can include links using technologies such as Ethernet, 802.11, worldwide interoperability for microwave access (WiMAX), 3G, 4G, LTE, 5G, WiFi, digital subscriber line (DSL), asynchronous transfer mode (ATM), InfiniBand, PCI Express Advanced Switching, etc. Similarly, the networking protocols used on the network 150 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 150 can be represented using technologies and/or formats, including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. The network 150 also includes links and packet-switching networks such as the Internet.

### Example Odor Gamut

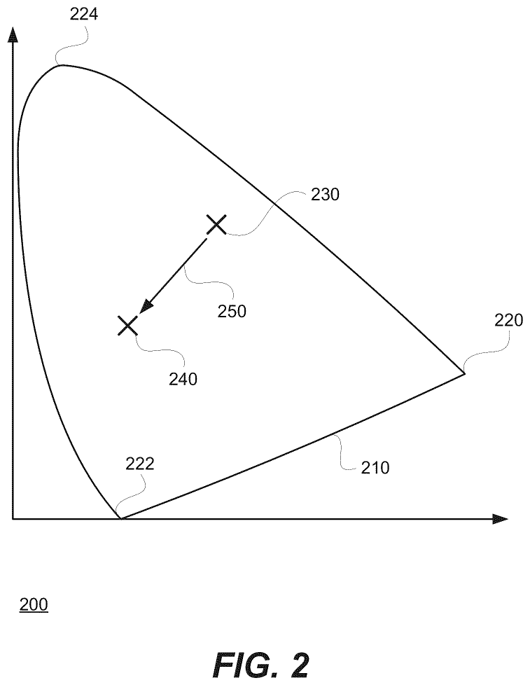

FIG. 2 is a conceptual diagram illustrating a conceptual representation of an example odor gamut, in accordance with some embodiments. The conceptual representation is illustrated as having a two-dimensional odor coordinate system 200 and a horseshoe-shaped odor gamut 210 with three primary odors 220, 222, and 224. Note that the illustration in FIG. 2 is merely a conceptual illustration that makes the odor gamut 210 resemble the concepts in the color gamut. In at least some actual embodiments, the odor gamut 210 is unlikely to take the horseshoe shape similar to a color gamut. Also, in at least some actual embodiments, the number of primary odors is likely more than three and, as such, the odor coordinate system 200 is likely to be in a high dimensional system that is not illustratable graphically. For example, in some embodiments, there are at least 10 primary odors and the odor gamut 210 may be in a 10-dimensional coordinate space.

In some embodiments, any odor in the odor gamut 210 may be represented by the combination of the primary odors 220, 222, and 224. In this conceptual illustration, the number of primary odors is 3, but in some embodiments, the combination may include more than 3 primary odors. The odor gamut concept may be used to store an odor, reproduce an odor, and alter an odor. For example, the odor 230 may be an odor that is recorded in an environment and is represented in the coordinate system as a combination (e.g., linear combination) of the three primary odors. In some embodiments, the data store 130 may store the coordinates in the form of a vector of primary odors, such as [0.4 primary odor 220, 0.2 primary odor 224, 0.4 primary odor 224]. In this particular example, the coordinates are normalized to 1 but in various embodiments, the coordinate systems do not need to be normalized. In some embodiments, this vector of primary odors may be stored as the digital representation of the odor 230. The vector may be transmitted to an olfactometer 140 to reproduce the odor 230.

In some embodiments, an odor gamut system may also be used to perform a controlled alteration of an odor, such as by changing a source odor to a target odor (e.g., from a foul smell to a pleasant smell). In the odor gamut 210, a second odor 240 is represented in another set of coordinates in the coordinate system 200. The odor 240 may represent a target odor 240 to which a source odor 230 may be converted. A computing device 120 may perform vector operations to determine a vector 250 that represents a target release mixture of primary odors that alters the source odor 230 to the target odor 240. For example, the target release mixture superimposes with the source odor 230 in the odor gamut 210 to generate the target odor 240. The computing device 120 may perform vector addition or subtraction that subtracts the target odor 240 from the source odor 230 to determine the vector 250. The target release mixture may be represented by a vector of primary odors and may be transmitted to an olfactometer 140 to release a chemical mixture corresponding to the target release mixture to convert the source odor 230 to the target odor 240. The use of an odor gamut may address the need for a simplified and standardized system of odor generation by developing a method for identifying a set of primary odors. The primary odors can be combined in various proportions to produce a wide range of other odors.

A vector of primary odors that serves as a digital representation of an odor may be generated from another digital format, such as a perceptual vector that corresponds to a set of odor characteristics. Perceptual vectors may be used as inputs for representing odors. In some embodiments, an odor may be assigned a perceptual vector which is a numerical designation and digital representation of the odor. Perceptual vectors may then be used as an example form of digital representation of odors to be used in, for example, to “transmit” an odor from one location to another location, where the odor can be regenerated without transmission of any physical matter between the two locations. Using an odor gamut and the system 100, a target odor can be regenerated from various sets of primary odorants. In some embodiments, these primary odorants can, in some cases, be entirely different from the original odor. For example, the original odor presented in an environment may be caused by a first set of chemicals. The primary odorants used to reproduce the odor may include a first set of chemicals. The two sets of chemicals may not include any molecules in common.

In some embodiments, a perceptual vector may include values for two or more odor characteristics which, together, describe a particular odor. The perceptual vector may be inputted by an odor input device 110. In some embodiments, an odor characteristic value may take the form of a numerical value that corresponds to how well an odor characteristic applies to the odor (e.g., the suitability or the perceived intensity of the characteristic). In some embodiments, the odor characteristic value ranges from 0-5 inclusive, including fractional numbers therebetween. For example, in some embodiments, a value of 0 indicates that the odor does not possess that odor characteristic at all, a value of 1 indicates that the aroma possesses that odor characteristic, but it is a minor component of the overall percept, while a value of 5 indicates that the odor characteristic is a major component of the overall percept. In some embodiments, one or more odor characteristic values are an average or arithmetic mean of odor characteristic values determined by human perceptions of users in the environment. In some embodiments, one or more odor characteristic values are generated by a computer based on the molecular structure or composition of chemicals associated with the odor. While a scale between 0 and 5 is used as an example of how the value of an odor characteristic may be defined, in various embodiments the value may be defined using any suitable parameters, whether the parameters are integers, discrete, continuous, or take any predefined range or not.

In some embodiments, a characterization of an odor may be defined by taking two or more odor characteristics that are selected from Table 1 to form a set of odor characteristics that have values for each odor characteristic.

TABLE 1
Examples of Odor Characteristic Labels

| | | | |
|---|---|---|---|
| Green | Cucumber | Herbal | Mint |
| Woody | Pine | Floral | Powdery |
| Fruity | Citrus | Tropical | Berry |
| Peach | Sweet | Caramellic | Vanilla |
| brown spice | smoky | burnt | roasted |
| grainy | meaty | nutty | fatty |
| coconut | waxy | dairy | buttery |
| cheesy | animal | sulfurous | onion/garlic |
| earthy | mushroom | musty | medicinal |
| phenolic | cooling | sharp | chlorine |
| alcoholic | plastic | rubber | fermented |
| sour | rotten/decay | fecal | ammonia |
| fishy | ozone | metallic | |

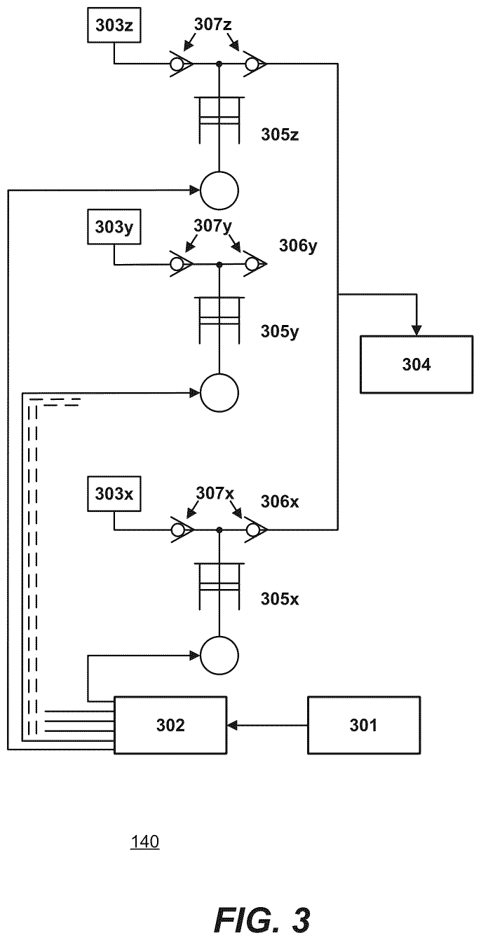

In some embodiments, the odor characteristics encompassed herein are not limited to those recited here. For example, it is possible that one or more of the odor-characteristic labels are changed from those recited in Table 1, or one or more odor-characteristic labels may be added to Table 1. Similar odor-characteristic labels have been described by the inventors. See, Lee et al., A Principal Odor Map Unifies Diverse Tasks in Human Olfactory Perception, bioRxiv 2022.09.01.504602; doi: https://doi.org/10.1101/2022.09.01.504602, posted Dec. 13, 2022, which is incorporated herein by reference herein for all purposes. In some embodiments, the odor characteristics described by Lee et al. are used (e.g., FIG. 3A of Lee et al.).

In some embodiments, a perceptual vector may include odor characteristic values for two or more odor characteristics. As a basic example, a perceptual vector can include odor characteristic values for two odor characteristics, for example, those listed in Table 1. For clarity, an example using the characteristics of grassy and fruity is provided below, in Table 2.

TABLE 2

| Odor Characteristic | Grassy | Fruity |
|---|---|---|
| Odor Characteristic Value | 2.2 | 4.7 |
| Perceptual vector | [2.2, 4.7] | |

In some embodiments, the odor characteristic value need not be a whole number but may be a fractional number. For example, an odor characteristic value may take an aggregation of a number of input values from different individuals who rated the odors.

In some embodiments, the perceptual vector includes any number of odor characteristics between 2 and 400 odor characteristics, each representing a single odor characteristic. In some embodiments, the perceptual vector includes any number of odor characteristics between 2 and 51 odor characteristics. In some embodiments, the perceptual vector includes any number of odor characteristics between 2 and 55 odor characteristics. In some embodiments, the perceptual vector includes any number of odor characteristics between 10 and 51 odor characteristics. In some embodiments, the perceptual vector includes any number of odor characteristics between 15 and 51 odor characteristics. In some embodiments, the perceptual vector includes any number of odor characteristics between 5 and 40 odor characteristics. In some embodiments, a perceptual vector has 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, or 51 odor characteristics. In some embodiments, a perceptual vector has 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 40, 41, 42, 43, 44, 45, 46, 47, 48, 49, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, or 400 odor characteristics. In some embodiments, a perceptual vector may include a number of odor characteristics that correspond to the basic or primary odors that the human nose is capable of detecting. For example, the number of odor characteristics may correspond to the number of types of smell receptors that a human nose has. In some embodiments, a perceptual vector may include a number of odor characteristics that correspond to the basic or primary odors that a target animal or a target living organism is capable of detecting.

The greater the number of values in the perceptual vector, the greater the resolution of the odor representation. Similar to how a greater number of pixels provides higher resolution in a digital display device, for most odors, a perceptual vector containing more values will provide a better representation of the odor than a perceptual vector containing fewer values.

In some embodiments, the number of odor characteristics in a perceptual vector may be limited to account only for those odor characteristics likely to be observed in the subject odors. For example, in perfumery, the desired odor gamut may not span percepts such as chlorine, rotten/decay, phenolic, etc. As such, in some embodiments, those odor characteristics need not be included in the perceptual vector. The odor characteristics and resultant perceptual vector can be tailored to the subject odor industry or the intended use of various target odors. However, in some embodiments, while the target odors such as in perfumery are not intended to include negatively perceived odors, the odor gamut may still span across certain unwanted odors because the system 100 may be used to alter an unwanted odor to a desired odor.

In some embodiments, the order of odor characteristics in a perceptual vector may vary. In some embodiments, the generator and final recipient of the perceptual vector may have a shared key that permits the vector to be deciphered by all interested parties. In some embodiments, a standard arrangement or order may be determined.

Continuing to refer to FIG. 2, in some embodiments, a set of primary odors is used to create a target odor. The set of primary odors may refer to two or more odors or odorants that can be mixed in varying amounts to produce a wide range of other odors. In some embodiments, the primary odors form the primary set of the odor gamut 210. In some embodiments, an odor gamut 210 may refer to the complete range of odors that can be created from a defined set of primary odors. While the odor gamut 210 shown in FIG. 2 is illustrated as having 3 primary odors, in various embodiments the span of an odor gamut may be different and may be based on the selection of primary odors.

In some embodiments, the set of primary odors may be curated based on the subject odor industry or the intended use of the target odors. In some embodiments, a system 100 may limit the number of odors or odorants in the primary set to the fewest number possible to reduce costs associated with the production of various subject odors. However, given that many odors or odorants can be interchanged with various similar components, the primary set of odors is variable, even within a particular industry or intended use.

In some embodiments, a set of primary odors may contain two or more odors or odorants. In some embodiments, a set of primary odors contains at least 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 or more components. An exemplary set of primary odors is shown below in Table 3. A set of primary odors may contain any subset of this exemplary set or various other odors in addition, or as substitutes for one or more of the odors of the exemplary set. The correlations between the compound identifiers (CID) and Chemical Abstracts Service identifiers (CAS ID) are shown in Table 4 below.

TABLE 3
Exemplary Primary Set

| ID | CIDs | Description |
|---|---|---|
| 1 | 8892; 18635 | Sulfurous; Rotten.Decay; Cheesy |
| 2 | 31276 | Fruity; Sweet; Tropical |
| 3 | 20499; 14286 | Roasted; Smoky; Grainy |
| 4 | 1183 | Green; Vanilla; Caramellic |
| 5 | 16666 | Cooling; Mint; Medicinal |
| 6 | 14286; 12813 | Waxy; Buttery; Coconut |
| 7 | 10890; 62444 | Dairy; Woody; Cheesy |
| 8 | 10886; 2758778 | Berry; Ozone; Woody |
| 9 | 37511 | Fishy; Ammonia; Garlic.Onion |
| 10 | 78944; 7222 | Sharp; Green; Rubber |
| 11 | 5367531 | Waxy; Coconut; Cucumber |
| 12 | 162053 | Floral; Powdery; Cucumber |
| 13 | 460; 16590 | Burnt; Garlic.Onion; Powdery |
| 14 | 7909; 439570 | Mushroom; Mint; Coconut |
| 15 | 637566 | Animal; Citrus; Cucumber |
| 16 | 76322; 6920 | Ozone; Metallic; Medicinal |
| 17 | 79104; 9261 | Alcoholic; Citrus; Mint |
| 18 | 7681 | Earthy; Mushroom; Ammonia |
| 19 | 12206; 18635 | Fatty; Peach; Buttery |
| 20 | 11702; 439570 | Mint; Medicinal; Earthy |
| 21 | 326; 20499 | Meaty; Mushroom; Buttery |
| 22 | 460; 6989 | Ozone; BrownSpice; Musty |
| 23 | 78949 | Fecal; Sour; Animal |
| 24 | 10400; 62444 | Coconut; Fecal; Dairy |
| 25 | 3314 | Coconut; BrownSpice; Pine |
| 26 | 11702; 7222 | Chlorine; Peach; Earthy |
| 27 | 7969; 5362720 | Cucumber; Green; Animal |
| 28 | 62465; 20499 | Sulfurous; Burnt; Phenolic |
| 29 | 10976; 62465 | Musty; Ozone; Metallic |
| 30 | 62465; 16590 | Smoky; Animal; BrownSpic e |
| 31 | 520098 | Musty; Buttery; Chlorine |
| 32 | 326; 6989 | Meaty; Herbal; Berry |
| 33 | 78944; 7335 | Plastic; Sharp; Phenolic |
| 34 | 326; 16590 | Meaty; Fatty; Sharp |
| 35 | 5324978 | Fishy; Ammonia; Powdery |
| 36 | 1032 | Fermented; Sour; Peach |
| 37 | 15651; 7222 | Phenolic; Earthy; Sulfurous |
| 38 | 62433 | Tropical; Berry; Herbal |
| 39 | 7765; 6989 | Plastic; Rubber; Woody |
| 40 | 10890; 7770 | Cheesy; Tropical; Herbal |
| 41 | 18840 | Rubber; Plastic; Cheesy |
| 42 | 6654 | Woody; Pine; Sharp |
| 43 | 7909; 16590 | Garlic.Onion; Green; Powdery |
| 44 | 460; 61527 | Smoky; Caramellic; Vanilla |
| 45 | 7144 | Vanilla; Floral; Caramellic |
| 46 | 10882 | Sweet; Berry; Nutty |
| 47 | 2758778 | Nutty; Grainy; Rotten.Decay |

TABLE 4

| CID | CAS | CID | CAS | CID | CAS |
|---|---|---|---|---|---|
| 8892 | 142-62-1 | 16590 | 2179-57-9 | 62465 | 2785-89-9 |
| 18635 | 3268-49-3 | 7909 | 108-10-1 | 10976 | 543-49-7 |
| 31276 | 123-92-2 | 439570 | 6485-40-1 | 7335 | 97-42-7 |
| 20499 | 4437-20-1 | 76322 | 2979-19-3 | 5324978 | 3082-64-2 |
| 14286 | 1122-62-9 | 6920 | 88-15-3 | 1032 | 79-09-4 |
| 16666 | 2216-51-5 | 79104 | 765-42-4 | 15651 | 1758-46-9 |
| 12813 | 706-14-9 | 9261 | 290-37-9 | 62433 | 2173-56-0 |
| 10890 | 540-18-1 | 7681 | 103-83-3 | 7765 | 105-57-7 |
| 62444 | 2432-51-1 | 12206 | 624-24-8 | 7770 | 105-66-8 |
| 10886 | 540-07-8 | 11702 | 597-49-9 | 18840 | 3400-45-1 |
| 2758778 | 38028-67-0 | 326 | 122-03-2 | 6654 | 80-56-8 |
| 37511 | 108-16-7 | 6989 | 89-83-8 | 61527 | 10599-70-9 |
| 78944 | 94-66-6 | 78949 | 120-74-1 | 7144 | 93-51-6 |
| 7222 | 95-16-9 | 10400 | 502-42-1 | 10882 | 539-82-2 |
| 5367531 | 30361-29-6 | 3314 | 97-53-0 | 6549 | 78-70-6 |
| 162053 | 41890-92-0 | 7969 | 108-98-5 | 7127 | 93-15-2 |
| 460 | 90-05-1 | 5362720 | 2277-19-2 | 12297 | 626-93-7 |

In some embodiments, an odor that is inputted by a user (a group of users) as a set of odor characteristics may be converted into a vector of primary odors, which describes a composition of primary odors that are predicted to reproduce the set of odor characteristics. For example, the set of odor characteristics may be converted into a set of coordinates in an odor gamut 210. The coordinate system of an odor gamut 210 may be defined by the primary odors as eigenvectors in the odor gamut 210.

In some embodiments, an odor gamut is in an N-dimensional space that is defined by N primary odors, and N is equal to or greater than 5. In some embodiments, an odor gamut is in an N-dimensional space that is defined by N primary odors, and N is equal to or greater than 10. In some embodiments, an odor gamut is in an N-dimensional space that is defined by N primary odors, and N is equal to or greater than 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100.

### Example Olfactometer

FIG. 3 is a block diagram illustrating an example design of an olfactometer 140, in accordance with some embodiments. The olfactometer 140 may be used to produce a wide variety of odors from a small palette of primary odors. The olfactometer 140 and the system 100 may be useful in applying in entertainment, transmitting odors, quantifying olfactory perception to record and share odors, quantifying the olfactory portion of flavor without human panels, replacing flavor and fragrance ingredients while preserving the perceptual target, targeted disruption of malodors, enabling trademarks for olfactory perception, and facilitating the training of new perfumers and flavorists.

In some embodiments, the olfactometer 140 may take various forms. For example, the olfactometer 140 may be a portable olfactometer. In some embodiments, the olfactometer 140 may be part of a larger entertainment system (e.g., a movie system that releases odor) or environment control system. An environment control system (not shown in figure) may be a system that control various factors in the environment, including temperature, odor, ambient light level, sound, humidity level, air circulation and ventilation, carbon dioxide levels, and even specific pollutants or contaminants in the air. The environment control system may be applied at home, in office, mall, spa, patient care institute, or another suitable setting to regulate an environment. In some embodiments, the olfactometer 140 may be a wearable electronic device, such as part of a virtual reality headset that has a display and sound system and an olfactometer 140 for the control of odor. In some embodiments, the olfactometer 140 may be installed at a predetermined location to control the odor of the environment, such as at certain areas that are susceptible to unpleasant smells.

In some embodiments, an olfactometer 140 may take the form of an odor generator for generating a target odor and/or to release a chemical mixture to alter a source odor to a target odor. The olfactometer 140 may include an input interface 301, a controller 302, one or more receptacles 303, a collector 304, one or more controls 305, one or more channels 306, and one or more valves 307. While three sets of some components are illustrated in FIG. 3, an olfactometer 140 in various embodiments may include any number of sets of components that are used to store different odor source materials.

In some embodiments, the olfactometer 140 may include an input interface 301 for inputting a digital representation of the target odor into a controller 302. The input interface 301 may take various suitable forms. For example, in some embodiments, the input interface 301 is a graphical user interface with input control elements such as keyboards or touchscreen to receive manual input from a user. In some embodiments, the input interface 301 may take the form of a communication interface such as a wired or wireless transceiver to receive commands or signals from another device, such as a computing device 120. In some embodiments, the input interface 301 may include an application programming interface (API) that is configured to communicate with another device. In some embodiments, the input interface 301 may receive a digital representation of an odor and provide the digital representation to the controller 302. In some embodiments, the interface 301 may take the form of a wireless interface that is in communication with a remote device, such as an odor input device 110 or a computing device 120, to receive digital representations of odors or direct control commands from the remote device. A remote device may be a user electronic device (e.g., smartphone), a controller, a remote server, or another suitable device.

The controller 302 may include one or more processors to perform data analysis and to control other components in the olfactometer 140. The controller 302 may take the form of a microprocessor, a microcontroller, and/or an integrated circuits that include various circuit components. The controller 302 may receive various digital representations of the odors, such as a vector of primary odors or a volume/mass composition of the chemicals. The processor may convert the digital representation that a format that is used to direct the controls to regulate the composition. In some embodiments, the controller 302 is physically located with the rest of the components of the olfactometer 140, such as being located within part of the housing of the olfactometer 140. In some embodiments, the controller 302 may be a remote controller that controls the olfactometer 140 wirelessly. For example, the controller 302 may be an electronic device such as a smartphone or a remote computing device that is used to control the rest of the components in the olfactometer 140. In some embodiments, the controller 302 may take the form of a general computing device that includes memory and one or more processors. The memory stores the code that includes instructions, which cause the one or more processors to perform various steps when executed.

The olfactometer 140 may include a number of receptacles 303x, 303y, and 303z that are used to store a set of odor sources. The receptacles may take any suitable forms such as tubes, flasks, cups, bottles, and the like. The set of odor source materials may be chemicals that are used to generate a target odor gamut. In some embodiments, each odor source in a receptacle may correspond to a primary odor that is a single odorant or a mixture of chemicals that generate the primary odor. In some embodiments, each odor source in a receptacle may correspond to a chemical that may not correspond to a primary odor. Instead, a few chemicals in different receptacles 303x, 303y, and 303z may reproduce a primary odor. When a vector of primary odors is received by the olfactometer 140, the controller 302 may convert the vector into a composition of chemicals that are contained in the receptacles 303x, 303y, and 303z.

In some embodiments, the receptacles 303 are configured to store at least 2 chemicals. In some embodiments, the receptacles 303 are configured to store at least 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 chemicals. In some embodiments, the receptacles 303 are configured to store at least 60, 70, 80, 90, or 100 chemicals.

The olfactometer 140 may also include a number of controls 305x, 305y, and 305z, each corresponding to a receptacle 303 and is used to control one of the receptacles 303. A control 305 may take any suitable forms such as an electroosmotic pump, rotary pump, blower, valve, switch, heater, adjustable opening, pressure regulator, and the like. The controls 305x, 305y, and 305z collectively adjust the composition of chemicals to be released.

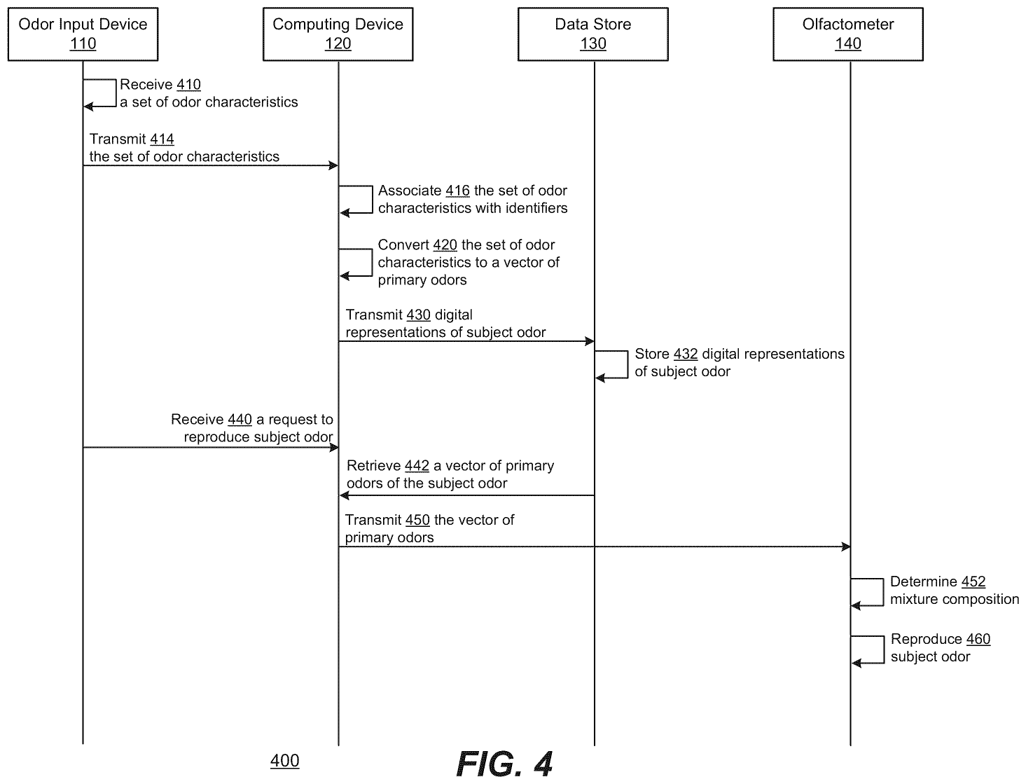

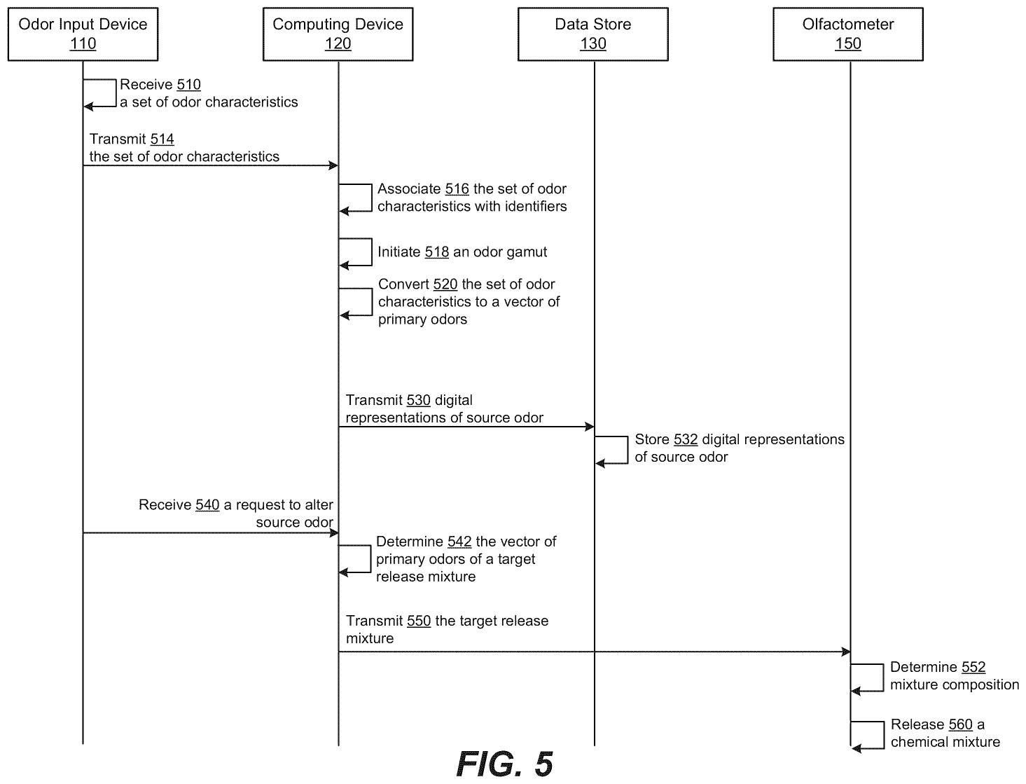

In some embodiments, the controller 302 is configured to (e.g., through executing of code instructions) receive a digital representation of a target odor. The digital representation represents the target odor that is quantified based on a combination of primary odors in an odor gamut. The controller 302 is further configured to generate commands to one or more controls 305 to release a target composition of the chemicals to generate the target odor. In some embodiments, the controller 302 is configured to store a plurality of digital representations of odors. In some embodiments, each digital representation is defined by an odor gamut that is defined by a plurality of primary odors. Each primary odor is defined by one or more component compounds that are stored in receptacles 303. The plurality of digital representations may represent a spectrum of odors that are within the odor gamut. The controller 302 may receive a request to generate a target odor. The controller 302 may determine a digital representation of the target odor. The digital representation of the target odor is representable by a composition of the component compounds. The controller 302 may transmit a command of the composition of the component compounds to the olfactometer 140 to release the target odor. In some embodiments, the controller 302 may perform any steps that are described in this disclosure, such as one or more steps that are discussed in FIG. 4 and FIG. 5, even for those steps that are not described in those example embodiments as performed by the olfactometer 140 or the controller 302.

In some embodiments, the olfactometer 140 may include a collector 304. A collector 304 may take the form of a simple chamber for collecting and mixing the chemicals before the mixture is released. The collector 304 may also include a disperser, which may take the form of an atomizer or vaporizer for atomizing or vaporizing the mixture to generate a target odor. In some embodiments, the olfactometer 140 may also include channels 306x, 306y, and 306z for connecting the controls 305x, 305y, and 305z to the collector 304. The channels 306x, 306y, and 306z may take the form of tubing, pipes, or any suitable channels. In some embodiments, the olfactometer 140 may also include valves 307x, 307y, and 307z for allowing the odor source materials to flow from the receptacles 303x, 303y, and 303z to the collector 304.

Through the use of odor gamut and a plurality of primary odors, in some embodiments, the olfactometer 140 is capable of producing a broad spectrum of odors based on mixtures of chemicals. In some embodiments, the olfactometer 140 is capable of producing at least 10 odors. In some embodiments, the olfactometer 140 is capable of producing at least 20 odors. In some embodiments, the olfactometer 140 is capable of producing at least 30 odors. In some embodiments, the olfactometer 140 is capable of producing at least 40 odors. In some embodiments, the olfactometer 140 is capable of producing at least 50 odors. In some embodiments, the olfactometer 140 is capable of producing at least 60 odors. In some embodiments, the olfactometer 140 is capable of producing at least 70 odors. In some embodiments, the olfactometer 140 is capable of producing at least 80 odors. In some embodiments, the olfactometer 140 is capable of producing at least 90 odors. In some embodiments, the olfactometer 140 is capable of producing at least 100 odors. In some embodiments, the olfactometer 140 is capable of producing at least 200 odors. In some embodiments, the olfactometer 140 is capable of producing at least 300 odors. In some embodiments, the olfactometer 140 is capable of producing at least 400 odors. In some embodiments, the olfactometer 140 is capable of producing at least 500 odors. In some embodiments, the olfactometer 140 is capable of producing any odors that are quantified in the odor gamut.

In some embodiments, the spectrum of odors is sourced by a number of end users characterizing the odors. For example, a computer program may query users in order to store various odors digitally and permanently. Any user may report an odor. An odor input device 110 may be presented and display an interface for the user to enter a set of odor characteristics. The computer program may convert the set of odor characteristics as a digital representation of the odor. The computer program may store the digital representation of the odor in a data store such that the odor is reproducible by using a combination of primary odors that define an odor gamut. The storage of odors and recreation of odors are further discussed in FIG. 5.

### Example Process for Reproducing an Odor

In some embodiments, the system 100 may be used to generate a subject odor. The process may include providing an olfactometer 140 with a perceptual vector of the subject odor, a vector of primary odors that represents the subject odor, or another digital representation of the subject odor. The olfactometer 140 may generate a formula for generating the subject odor. The formula may take the form of a set of values corresponding to a specific amount of each of the two or more primary odors available in the olfactometer 140. The formula may be different for each subject target odor vector for each different set of primary odors. In some embodiments, a computing device 120 may use a model to predict the component odors from the set of primary odors that are combined into the subject odor. The olfactometer 140 may generate the target odor mixture using the formula. In some embodiments, the odor is retained in a collector 304 as a contain of the subject odor. In some embodiments, the odor is dispersed.

In some embodiments, a system 100 may generate an odor gamut that can be used to digitally identify and document odors using vectors of primary odors. The process may include providing a computing device 120 that includes a model that predicts olfactory properties of combinations of two or more odors based on a perceptual vector for each of the odors in the selected primary set. In some embodiments, the model may use the various techniques described herein based on the component values to determine various combinations of the set of primary odors.

In some embodiments, a system 100 may select a set of primary odors that can be used to generate one or more subject odors. A computing device 120 may include a model that predicts olfactory properties of combinations of two or more odors based on the perceptual vector for each of the odors in a group of candidate primary odors. The computing device 120 may receive the perceptual vectors of one or more subject odors. The model may use the various techniques described herein to select a set of primary odors from the candidate's primary odors.

In some embodiments, a computing device 120 may include an algorithm to predict the odor characterizations of complex mixtures. In olfaction, conventionally, the rules for mixing molecules to create odors are poorly understood at a quantitative level. The computing device 120 may include a linear additive model to define the odors of various complex mixtures. In some embodiments, the computing device 120 may use additional high-quality psychophysical data to generate one or more constrained nonlinear models. For example, the computing device 120 may measure the perceived similarity of 2700 mixture pairs. The data and model allow researchers to identify psychophysical metamers that are made up of different chemicals but are perceptually indistinguishable.

FIG. 4 is an example sequence diagram illustrating an example series 400 for reproducing an odor, in accordance with some embodiments. Some steps in series 400 illustrated in FIG. 4 may represent sets of instructions that may be stored in one or more computer-readable media, such as the memory of different computing devices. The instructions, when executed by one or more processors, cause one or more processors to perform the described actions. As depicted in FIG. 4, the series 400 may involve an odor input device 110, a computing device 120, a data store 130, and an olfactometer 140. These components are merely examples that are used to illustrate some functionalities of the system 100. In various embodiments, the system 100 may not contain the precise components shown in the series 400 and the functionalities may be distributed differently than the example shown in the series 400. Also, while series 400 is illustrated as a sequence of steps, each step in series 400 may not follow the precise order as illustrated in FIG. 4. One or more steps may also be added, omitted, changed, or merged in various embodiments. Note that even without explicit references, one or more steps or features that are described in process 500 associated with FIG. 5 below may also be used in process 400.

In some embodiments, an odor input device 110 may receive 410 a set of odor characteristics of a subject odor. An odor characteristic in the set may take the form of a perception of the intensity of the odor characteristic. The set of odor characteristics may be referred to as a perceptual vector.

The set of odor characteristics may be inputted to the odor input device 110 in various manners. For example, in some embodiments, a computing device 120 may cause the odor input device 110 to display a user interface that allows a user to input a scale for each of the set of odor characteristics. The odor input device 110 may receive an input from the user inputting the set of odor characteristics. The input may include the scale for each of the set of odor characteristics. The odor input device 110 may transmit 414 the set of odor characteristics to the computing device 120. The computing device 120 receives the set of odor characteristics. The computing device 120 may associate 416 the set of odor characteristics with an odor identifier and also associate the odor identifier with a user identifier corresponding to the user.

Alternatively, or additionally, the odor input device 110 may receive, from a user, an indication of a familiar smell in the environment. The computing device 120 may cause an odor input device 110 to display a list of familiar smell candidates. The odor input device 110 may receive a selection of a familiar smell candidate from the user as the subject odor. The computing device 120 may store a predefined set of odor characteristics as the characterization of the subject odor. In some embodiments, after a user selects a familiar smell candidate, the odor input device 110 may also display the predefined set of odor characteristics and allow the user to fine-tune the scales of the odor characteristics.

Alternatively, or additionally, odor input device 110 may also include odor sensors that automatically generate the set of odor characteristics.

In some embodiments, the set of odor characteristics may be selected from one or more odor characteristics from Table 1.

In some embodiments, the computing device 120 may receive multiple sets of odor characteristics of the same subject odor from one or more odor input devices 110. For example, multiple users may input the odor characteristics. In some embodiments, the computing device 120 may aggregate the user inputs to generate a version of the set of odor characteristics that are aggregated from various users' inputs.

In some embodiments, the computing device 120 may convert 420 the set of odor characteristics to a vector of primary odors. The vector of primary odors may define the odor in an odor gamut. For example, the computing device 120 may select N primary odors. The computing device 120 may define an N-dimensional space that is defined by the N primary odors. The N-dimensional space corresponds to the odor gamut. The number N of primary odors may be determined based on how the odor gamut is defined, as discussed above in association with FIG. 2. Each primary odor in the odor gamut may be associated with its own set of odor characteristics. Based on the set of odor characteristics of the subject odor, the computing device 120 may determine a set of coordinates for the subject odor in the odor gamut based on the combination of primary odors that generates the set of odor characteristics of the subject odor. For example, each dimension of the odor gamut may be defined by a primary odor. The set of coordinates for the subject odor in the odor gamut may take the form of a linear combination of primary odor vectors that generate the set of odor characteristics of the subject odor. The set of coordinates is used to represent the subject odor and may be stored as the vector of primary odors.

In some embodiments, each of the primary odors corresponds to a mix of one or more chemical compounds that generate said each of the primary odors. For example, a primary odor may include one or more odor characteristics. In some embodiments, a primary odor may correspond to an odorant. In some embodiments, a primary odor may correspond to one or more eigenvectors in an odor gamut that is able to generate a large span of the odor gamut. In such cases, a primary odor may be a mixture of chemical compounds. In some embodiments, the chemical compounds are naturally occurring aroma compounds so that the primary odors and the odors generated by the primary odors are safe to use. In some embodiments, primary odors in an odor gamut may include attributes of any of the combinations discussed herein.

In some embodiments, the computing device 120 may transmit 430 one or more digital representations of the subject odor to a data store 130. The digital representations may include an odor identifier, one or more user identifiers associated with one or more users who inputted the odor characteristics, one or more sets of odor characteristics (e.g., an aggregated set or individual sets from different users), and the vector of primary odors that is used to represent the subject odor in the odor gamut. The data store 130 may store 432 digital representations, such as storing the vector of primary odors as a digital representation of the odor.

In some embodiments, the computing device 120 may receive 440 a request from an odor input device 110 such as a user device to reproduce the subject odor. The odor input device 110 may be the same odor input device 110 that inputted the original odor characteristics of the subject odor or may be a different device. The odor input device 110 may be in the same physical location as the original device or in a different location. The two locations may be completely unrelated and geographically separated. The timing of the request may be days, weeks, months, or even years after the original set of odor characteristics was sent and the digital representation of the subject odor was stored. The timing of the request may also be real-time or near real-time compared to when the original set of odor characteristics was sent and the digital representation of the subject odor was stored. The computing device 120 may retrieve 442 the vector of primary odors of the subject odor from the data store 130. The computing device 120 may also retrieve other forms of digital representations of the subject odor.

In some embodiments, the computing device 120 may transmit 450 the vector of primary odors that represents the subject odor to an olfactometer 140, which may be located in an environment in which the subject odor is intended to be reproduced. Alternatively, or additionally, the computing device 120 may transmit another form of digital representation of the odor to the olfactometer 140. For example, the computing device 120 may directly determine, based on the vector, the mixture composition of chemicals that are used to generate the subject odor and transmit the chemical composition to the olfactometer 140. Alternatively, or additionally, the computing device 120 may also transmit the set of odor characteristics to the olfactometer 140. Depending on the type of digital representation received by the olfactometer 140, the olfactometer 140 may determine 452 the mixture composition of chemicals that are used to generate the subject odor.

In some embodiments, the olfactometer 140 may include a plurality of receptacles. Each of the receptacles is configured to store one of the primary odors or a chemical compound that is used to generate one or more primary odors. In some embodiments, each of the primary odors corresponds to a mix of one or more chemical compounds that generate said each of the primary odors. The olfactometer 140 may also include a set of controls. Each control corresponds to one of the receptacles and is configured to control a release of one of the primary odors based on the composition of the primary odors. The olfactometer 140 may reproduce 460 the subject odor using a composition of the primary odors determined based on the vector that corresponds to the digital representation of the odor. In some embodiments, the composition of the primary odors is controlled by volume, pressure, or concentration. In some embodiments, the olfactometer 140 reproduces 460 the subject odor in an environment at which a requesting user is located.

In some embodiments, the computing device 120 may transmit 450 the vector of primary odors to multiple olfactometers 140 to reproduce 460 the subject odor in different environments.

### Example Process for Altering an Odor

FIG. 5 is an example sequence diagram illustrating an example series 500 for altering an odor, in accordance with some embodiments. Some steps in series 500 illustrated in FIG. 5 may represent sets of instructions that may be stored in one or more computer-readable media, such as the memory of different computing devices. The instructions, when executed by one or more processors, cause one or more processors to perform the described actions. As depicted in FIG. 5, the series 500 may involve an odor input device 110, a computing device 120, a data store 130, and an olfactometer 140. These components are merely examples that are used to illustrate some functionalities of the system 100. In various embodiments, the system 100 may not contain the precise components shown in the series 500 and the functionalities may be distributed differently than the example shown in the series 500. Also, while the series 500 is illustrated as a sequence of steps, each step in the series 500 may not follow the precise order as illustrated in FIG. 5. One or more steps may also be added, omitted, changed, or merged in various embodiments. Note that even without explicit references, one or more steps or features that are described in process 400 associated with FIG. 4 above may also be used in process 500.

In some embodiments, an odor input device 110 may receive 510 a set of odor characteristics of a source odor. The process 500 may be used to alter the source odor to a target odor (e.g., from an unpleasant odor to a neural/pleasant odor). An odor characteristic in the set may take the form of a perception of the intensity of the odor characteristic. The set of odor characteristics may be referred to as a perceptual vector. In some embodiments, the odor input device 110 may receive an input of the set of odor characteristics by a user in the environment.

The set of odor characteristics may be inputted to the odor input device 110 in various manners. For example, in some embodiments, a computing device 120 may cause the odor input device 110 to display a user interface that allows a user to input a scale for each of the set of odor characteristics. The odor input device 110 may receive an input from the user inputting the set of odor characteristics. The input may include the scale for each of the set of odor characteristics. The odor input device 110 may transmit 514 the set of odor characteristics to the computing device 120. The computing device 120 receives the set of odor characteristics. The computing device 120 may associate 516 the set of odor characteristics with an odor identifier and also associate the odor identifier with a user identifier corresponding to the user.

Alternatively, or additionally, the odor input device 110 may receive, from a user, an indication of a familiar smell in the environment. The computing device 120 may cause an odor input device 110 to display a list of familiar smell candidates. The odor input device 110 may receive a selection of a familiar smell candidate from the user as the subject odor. The computing device 120 may store a predefined set of odor characteristics as the characterization of the subject odor. For example, the odor input device 110 may receive, from a user, an indication of foul smell in the environment. The computing device 120 may cause the odor input device 110 to display a list of foul smell candidates. The odor input device 110 may receive a selection of a foul smell candidate from the user as the source odor. Each foul smell candidate may be associated with a predefined set of odor characteristics as the characterization of the source odor. The computing device 120 may store the predefined set of odor characteristics. In some embodiments, after a user selects a familiar smell candidate, the odor input device 110 may also display the predefined set of odor characteristics and allow the user to fine-tune the scales of the odor characteristics.

Alternatively, or additionally, odor input device 110 may also include odor sensors that automatically generate the set of odor characteristics.

In some embodiments, the set of odor characteristics may be selected from one or more odor characteristics from Table 1.

In some embodiments, the computing device 120 may initiate 518 an odor gamut that is defined by a plurality of primary odors. The computing device 120 may convert 520 the set of odor characteristics representing the source odor to a vector of primary odors.

In some embodiments, each primary odor is defined by one or more component compounds. For example, in some embodiments, each of the primary odors corresponds to a mix of one or more chemical compounds that generate said each of the primary odors. For example, a primary odor may include one or more odor characteristics. In some embodiments, a primary odor may correspond to an odorant. In some embodiments, a primary odor may correspond to one or more eigenvectors in an odor gamut that is able to generate a large span of the odor gamut. In such cases, a primary odor may be a mixture of chemical compounds. In some embodiments, the chemical compounds are naturally occurring aroma compounds so that the primary odors and the odors generated by the primary odors are safe to use. In some embodiments, primary odors in an odor gamut may include attributes of any of the combinations discussed herein.

In some embodiments, the computing device 120 may initiate 518 the odor gamut in various suitable ways. For example, in some embodiments, the computing device 120 may identify a first subset of primary odors that are used to generate the source odor. The computing device 120 may identify a second subset of primary odors that are used to generate a target odor. The computing device 120 may determine a union set of primary odors that is a union of the first and second subsets of primary odors. The computing device 120 may use the union set of primary odors to generate the odor gamut. In some embodiments, the computing device 120 may select N primary odors. The number N of primary odors may be determined based on how the odor gamut is defined, as discussed above in association with FIG. 2. The computing device 120 may define an N-dimensional space that is defined by the N primary odors. The computing device 120 may represent the source odor and the target odor as vectors in the N-dimensional space.

The determination of the vector of primary odors representing the source odor may be performed based on the odor gamut. In some embodiments, based on the set of odor characteristics of the source odor, the computing device 120 may determine a set of coordinates for the source odor in the odor gamut based on the combination of primary odors that generates the set of odor characteristics of the source odor. For example, each dimension of the odor gamut may be defined by a primary odor. The set of coordinates for the source odor in the odor gamut may take the form of a linear combination of primary odor vectors that generate the set of odor characteristics of the source odor. The set of coordinates is used to represent the source odor and may be stored as the vector of primary odors.

In some embodiments, the computing device 120 may transmit 530 one or more digital representations of the source odor to a data store 130, which includes a storage medium. The digital representations may include an odor identifier, one or more user identifiers associated with one or more users who inputted the odor characteristics, one or more sets of odor characteristics (e.g., an aggregated set or individual sets from different users), and the vector of primary odors that is used to represent the subject odor in the odor gamut. The data store 130 may store 532 digital representations, such as storing the vector of primary odors as a digital representation of the odor.

In some embodiments, the computing device 120 may receive 540 a request from an odor input device 110 such as a user device to alter the source odor. The odor input device 110 may be the same odor input device 110 that inputted the original odor characteristics of the source odor or may be a different device. The odor input device 110 may be in the same physical location as the original device or in a different location. The two locations may be completely unrelated and geographically separated. The timing of the request may also be real-time or near real-time compared to when the original set of odor characteristics was sent and the digital representation of the source odor was stored. For example, an unpleasant odor may be detected and a request is sent in real-time for system 100 to remedy the situation by altering the odor. The timing of the request may be days, weeks, months, or even years after the original set of odor characteristics was sent and the digital representation of the source odor was stored. For example, a past unpleasant odor was detected in one location and the same unpleasant odor was detected again in another location. In some embodiments, the request to alter the source odor may include a selection of a target odor. In some embodiments, the request to alter the source odor may be associated with a detection report and the computing device 120 may automatically determine a target odor, such as based on the availability of primary odors in an olfactometer 140 that is present in the environment of the source odor.

In some embodiments, the computing device 120 may determine 542 a target-release mixture of the primary odors that alters the source odor to a target odor. The target release mixture may superimpose with the source odor in the odor gamut to generate the target odor. The target release mixture may be represented by a vector of primary odors. The determination of the vector that represents the target release mixture is further discussed in FIG. 2 associated with vector 250. For example, in some embodiments, the computing device 120 may generate a first coordinate in the odor gamut to represent the source odor. The computing device 120 may generate a second coordinate in the odor gamut to represent the target odor. The computing device 120 may determine a vector of compositions of primary odors in which the first coordinate is added with the vector in the odor gamut to generate the second coordinate. The computing device 120 may determine the target release mixture using the vector of compositions of primary odors.

In some embodiments, the target odor may be a neural odor that is used to neural the source odor. The computing device 120 may determine a vector that represents the target release mixture to neutralize the source odor or to remove one or more undesired odor characteristics associated with the source odor. For example, the computing device 120 may generate a first coordinate in the odor gamut to represent the source odor. The computing device 120 may generate an opposite vector that removes one or more odor characteristics of the source odor represented by the first coordinate. The computing device 120 may generate the target release mixture based on the opposite vector. The target release mixture is projected to neutralize the source odor.

In some embodiments, the computing device 120 may transmit 550 the target release mixture to an olfactometer 140 to cause the olfactometer to release, in an environment where the source odor is present, a chemical mixture corresponding to the target release mixture to convert the source odor to the target odor. The target release mixture, in digital form, may be in various different formats. For example, the target release mixture may take the form of a composition of the primary odors such that the olfactometer 140 is configured to release the chemical mixture according to the composition of the primary odors. In some embodiments, the target release mixture may be converted from a vector of primary odors to the direct compositions of chemicals available in the olfactometer 140. In some embodiments, the target release mixture may take the form of a set of odor characteristics for the olfactometer 140 to determine the chemical compositions. Other formats are also possible.

Depending on the type of digital representation received by the olfactometer 140, the olfactometer 140 may determine 552 the mixture composition of chemicals that are used to alter the source odor. In some embodiments, the olfactometer 140 may include a plurality of receptacles. Each of the receptacles is configured to store one of the primary odors or a chemical compound that is used to generate one or more primary odors. In some embodiments, each of the primary odors corresponds to a mix of one or more chemical compounds that generate said each of the primary odors. The olfactometer 140 may also include a set of controls. Each control corresponds to one of the receptacles and is configured to control a release of one of the primary odors based on the composition of the primary odors. The olfactometer 140 may release 460 a chemical mixture using a composition of the primary odors determined based on the vector that corresponds to the target release mixture. In some embodiments, the composition of the primary odors is controlled by volume, pressure, or concentration. In some embodiments, the olfactometer 140 releases 460 a chemical mixture in an environment at which a requesting user is located. In some embodiments, the source odor corresponds to a foul smell in the environment, and the olfactometer 140 is configured to release the chemical mixture to change the foul smell to the target odor.

### Experimental Result

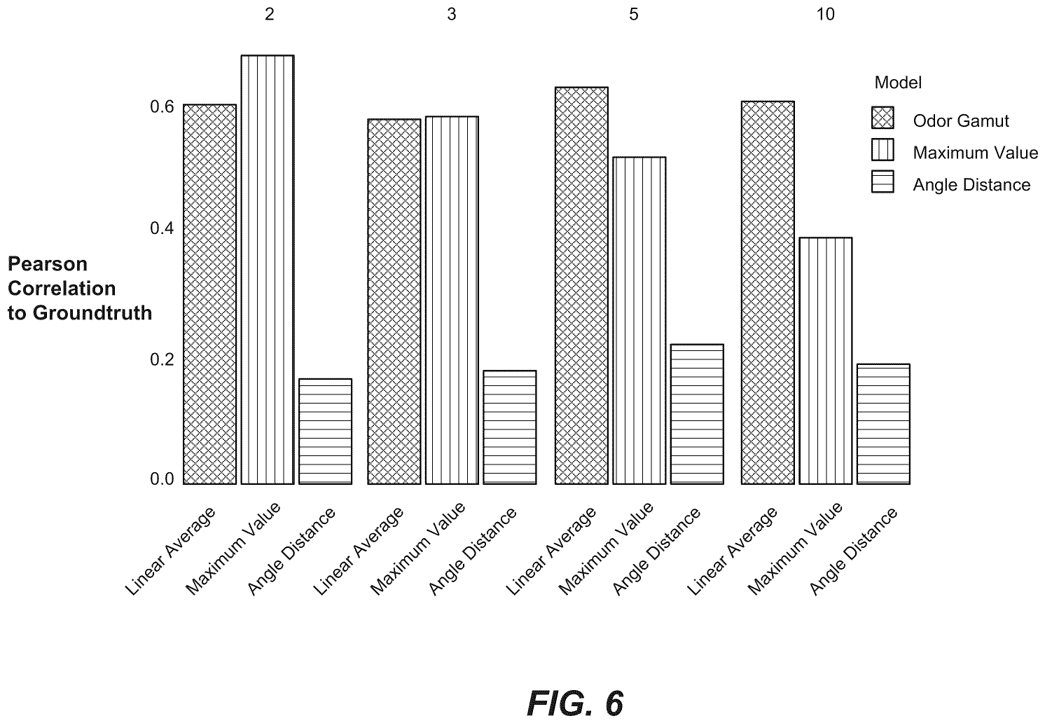

FIG. 6 is a bar chart illustrating an experimental result of using odor gamut to digitalize odors, in accordance with some embodiments. FIG. 6 compares the results of using an odor gamut approach that may use a linear combination of primary odors to document various odors to the results of other approaches such as the maximum value approach and angle distance approach. The y-axis shows the Pearson correlation values to the ground truth. The X-axis represents the number of molecules in a given odor. FIG. 6 shows that the odor gamut approach has a comparable performance compared to the maximum value approach when the odor is relatively simple and that the odor gamut approach significantly outperforms other approaches when the odor is more complex.

### Example Applications

While various examples of embodiments described in this disclosure are discussed in association with various components associated with the system 100, some embodiments do not need to be performed with any components (or with only one or two components) of the system 100. For example, the color gamut approach disclosed in FIG. 2 may be used to perform odor research in the fragrance industry and other institutes that research odors. The color gamut approach allows researchers to accurately and digitally document and describe various odors. One or more processors and apparatuses associated with the color gamut approach may be claimed without the involvement of any components of the system 100. For example, one or more processors of digitally or physically storing, digitally or physically re-creating, and digitally or physically altering odors may be claimed without the mention of any components of system 100.

The concepts and components discussed above are useful in various applications in multiple industries. In some embodiments, methods, compositions, and apparatuses are provided for generating a target odor from a specific set of primary odors. The information provided herein allows a target odor to be generated from any number of sets of primary odors using the perceptual vectors for that primary set, by combining the component perceptual vectors to arrive at the target odor perceptual vector, using the methods described herein. There are myriad uses for the aspect. For example, in the context of movie such as in a Smell-O-Vision system, an olfactometer may be used to recreate an odor that can be standardized using the digital representation. In the context of a virtual reality environment can be made more immersive by adding the dimension of smell. The acrid smell of gun smoke in a battlefield simulation or the smell of oil and rubber in a racing game could greatly enhance the VR gaming experience. In e-commerce, online shoppers can smell products like perfumes or candles before buying, adding a new layer to the shopping experience. In therapeutic situations, target aromas could be created to help treat conditions like anxiety and depression, enhancing the effectiveness of therapeutic practices. In the culinary arts, it is possible to recreate the smell of a dish before trying out a recipe or ordering food online. The described methods are useful in simulations to train individuals for jobs in specific environments, such as firefighters or perfumers, by recreating the scents associated with those environments.

In some embodiments, the perceptual vector is provided to a system 100 suitable for generating a subject odor. The system 100 is capable of combining two or more odors from a set of primary odors associated with the system 100 to arrive at the subject odor. In some embodiments, the system 100 is programmed with a model trained to provide a specific formula that comprises a specific amount of each of the two or more odors from the primary set to arrive at the subject odor.

In some embodiments, methods, compositions, and apparatuses are provided for generating the gamut of odors that can be created using a particular primary set. For example, the information provided herein allows for elucidation of all target odors that may be generated from a specific set of primary odors, created by combining the component perceptual vectors to arrive at the target odor perceptual vectors. In one embodiment, the perceptual vectors for a primary set of odors are provided to a device including a model as described herein. The device then generates the perceptual vectors for each odor that is capable of being created using that primary set.

In some embodiments, methods, compositions, and apparatuses are provided for generating a set of primary odors that is useful to generate a target gamut of odor vectors. In some embodiments, the perceptual vectors for a gamut of odors are provided to a device comprising a model as described herein. The device then generates the perceptual vectors for odor in a primary set that is capable of generating said gamut.

In some embodiments, the perceptual vectors used to train the model described herein are all from human panels, rather than predicted from structure. Lee et al describe a Principal Odor Map that provides a map of structure-odor relationships for single molecules. See, e.g., FIG. 1F of Lee. Using the model in Lee et al., the system 100 can also generate vectors for any single molecule from molecular structure. By combining the model of Lee and the model described herein it is possible to vectorize any odor where the system 100 knows the structure of the component odors (useful for high-throughput screening and screening novel molecules) or any odor where a human panel may be used to smell the odor. This process may be used to replace or supplement an analytical breakdown of all molecules in a complex mixture.

### Example Model Training and Structure

In some embodiments, a computing device 120 may use a model trained to predict olfactory properties of combinations of two or more odors. In some embodiments, the model is a machine learning model. In some embodiments, the model is trained using sets of combinations of two or more odors, termed component odor A and component odor A′. The resulting combination is termed combination odor A. In some embodiments, the combination odor is generated from more than two component odors, such as A′, A″, A′″, etc. The perceptual vector for each component odor A, component odor A′ (and so forth if needed), and combination odor A are defined, as described herein. The model is trained by inputting the perceptual vector for each component odor A, component odor A′ (and so forth), and combination odor A. The model is able to predict the combination odor perceptual vector from the component perceptual vectors. The perceptual vector of a combination can be well approximated by a simple average, or arithmetic mean, of the component perceptual vectors.

Multiple sets of combinations of odors are used in training the model. In some embodiments, at least 100, 150, 200, 250, 300, 350, 400, 450, 500, 600, 700, 800, 900, 1000, 1500, 2000, 2500, 3000, 3500, 4000, 4500, 5000, 10000, 50000, 100000 or more sets are used. In some embodiments, about 2700 sets are used.

In various embodiments, a wide variety of machine-learning techniques may be used. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN), and long short-term memory networks (LSTM), may also be used. For example, various prediction tasks of predicting odor characteristics of a given composition may be used in process 400 and process 500, such as determination of a vector of primary odors given a set of odor characteristics, determination of odor characteristics given a set of chemicals that generate an odor, and other processes may apply one or more machine learning and deep learning techniques.

In various embodiments, the training techniques for a machine learning model may be supervised, semi-supervised, or unsupervised. In supervised learning, the machine learning models may be trained with a set of training samples that are labeled. For example, for a machine learning model trained to make a prediction of the vector of primary odors, the training samples may be datasets generated from known odors with their odor characteristics and labels of vectors. For a machine learning model trained to make a prediction of odor characteristics based on a mixture of compounds, the training samples may include data on known compound composition and labels of odor characteristics.

By way of example, the training set may include multiple known records of datasets generated by odor samples with known chemical properties and/or odor characteristics. Each training sample in the training set may correspond to a past and the corresponding outcome may serve as the label for the sample. A training sample may be represented as a feature vector that includes multiple dimensions. Each dimension may include data of a feature, which may be a quantized value of an attribute that describes an odor sample. For example, in a machine learning model that is used to analyze odors, the features in a feature vector may include the various odors characteristics or various chemical compounds characteristics. In various embodiments, certain pre-processing techniques may be used to normalize the values in different dimensions of the feature vector.

In some embodiments, an unsupervised learning technique may be used. The training samples used for an unsupervised model may also be represented by features vectors, but may not be labeled. Various unsupervised learning techniques such as clustering may be used in determining similarities among the feature vectors, thereby categorizing the training samples into different clusters. In some cases, the training may be semi-supervised with a training set having a mix of labeled samples and unlabeled samples.

A machine learning model may be associated with an objective function, which generates a metric value that describes the objective goal of the training process. The training process may intend to reduce the error rate of the model in generating predictions. In such a case, the objective function may monitor the error rate of the machine learning model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels. In some embodiments, in a model that is used to analyze odors, the objective function may correspond to a loss function that compares the predicted odor characteristics or values in the vector of primary odors using the model and the actual labels of vector values or odor characteristic value. In various embodiments, the error rate may be measured as cross-entropy loss, L1 loss (e.g., the sum of absolute differences between the predicted values and the actual value), and L2 loss (e.g., the sum of squared distances).

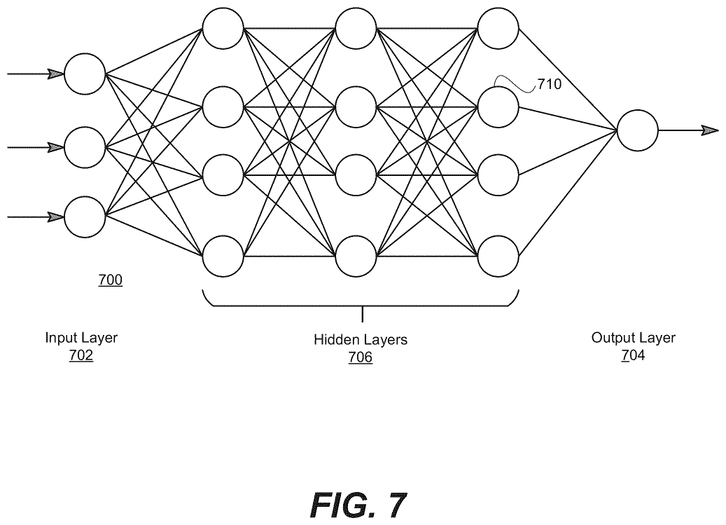

Referring to FIG. 7, the structure of an example neural network is illustrated, in accordance with some embodiments. The neural network 700 may receive an input and generate an output. The input may be the feature vector of a training sample in the training process and the feature vector of an actual case when the neural network is making an inference. The output may be the prediction, classification, or another determination performed by the neural network. The neural network 700 may include different kinds of layers, such as convolutional layers, pooling layers, recurrent layers, fully connected layers, and custom layers. A convolutional layer convolves the input of the layer (e.g., an image) with one or more kernels to generate different types of images that are filtered by the kernels to generate feature maps. Each convolution result may be associated with an activation function. A convolutional layer may be followed by a pooling layer that selects the maximum value (max pooling) or average value (average pooling) from the portion of the input covered by the kernel size. The pooling layer reduces the spatial size of the extracted features. In some embodiments, a pair of convolutional layers and a pooling layer may be followed by a recurrent layer that includes one or more feedback loops. The feedback may be used to account for spatial relationships of the features. The layers may be followed by multiple fully connected layers that have nodes connected to each other. The fully connected layers may be used for classification and object detection. In some embodiments, one or more custom layers may also be presented for the generation of a specific format of the output.

The order of layers and the number of layers of the neural network 700 may vary in different embodiments. In various embodiments, a neural network 700 includes one or more layers 702, 704, and 706. A machine learning model may include certain layers, nodes 710, kernels, and/or coefficients. Training of a neural network, such as the NN 700, may include forward propagation and backpropagation. Each layer in a neural network may include one or more nodes, which may be fully or partially connected to other nodes in adjacent layers. In forward propagation, the neural network performs the computation in the forward direction based on the outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Training of a machine learning model may include an iterative process that includes iterations of making determinations, monitoring the performance of the machine learning model using the objective function, and backpropagation to adjust the weights (e.g., weights, kernel values, coefficients) in various nodes 710. For example, a computing device may receive a training set that includes known odor samples and their corresponding odor characteristics and vectors of primary odors. Each training sample in the training set may be assigned labels indicating one or more odor characteristics and/or one or more values in vectors of primary odors. The computing device, in forward propagation, may use the machine learning model to generate the predicted odor characteristics and vector values of one or more training samples. The computing device may compare the predicted values with the labels of the training sample. The computing device may adjust, in a backpropagation, the weights of the machine learning model based on the comparison. The computing device backpropagates one or more error terms obtained from one or more loss functions to update a set of parameters of the machine learning model. The backpropagation may be performed through the machine learning model and one or more of the error terms based on a difference between a label in the training sample and the generated predicted value by the machine learning model.

By way of example, each of the functions in the neural network may be associated with different coefficients (e.g., weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tan h), and rectified linear unit functions (ReLU). After input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the machine learning model has converged) or after a predetermined number of rounds for a particular set of training samples.

In various embodiments, the training samples described above may be refined and continue to re-train the model, which is the model's ability to perform the inference tasks. In some embodiments, this training and re-training process may repeat, which results in a computer system that continues to improve its functionality through the use-retraining cycle. For example, after the model is trained, multiple rounds of re-training may be performed. The process may include periodically retraining the machine learning model. The periodic retraining may include obtaining an additional set of training data, such as through other sources, by usage of users, and by using the trained machine learning model to generate additional samples. The additional set of training data and later retraining may be based on updated data describing updated parameters in training samples. The process may also include applying the additional set of training data to the machine learning model and adjusting the parameters of the machine learning model based on the application of the additional set of training data to the machine learning model. The additional set of training data may include any features and/or characteristics that are mentioned above.

### Computing Machine Architecture

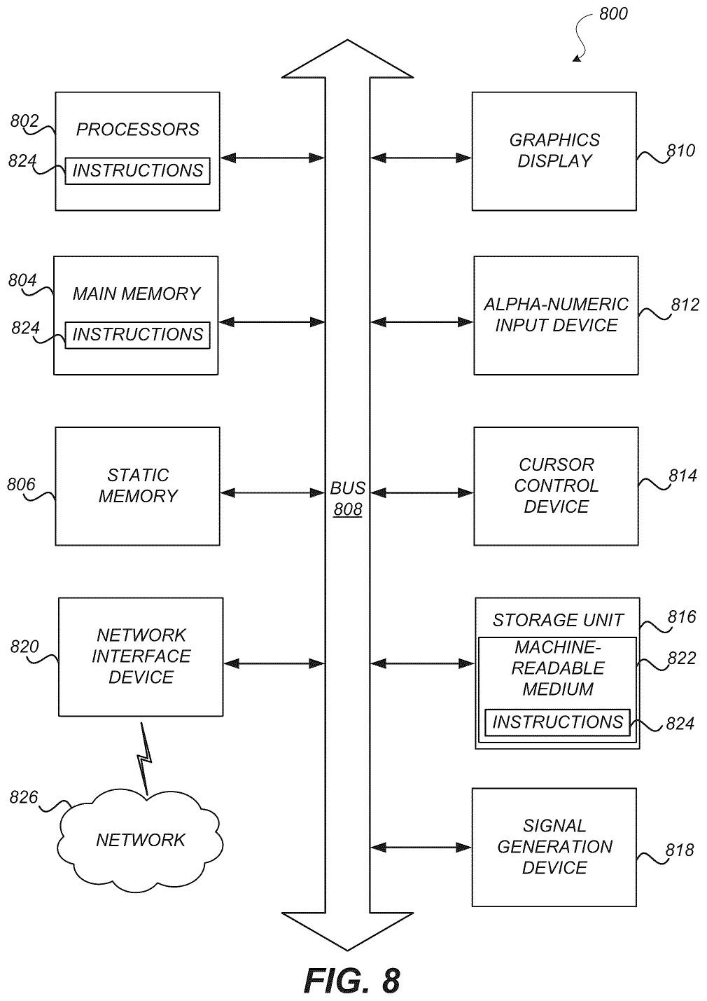

FIG. 8 is a block diagram illustrating components of an example computing machine that is capable of reading instructions from a computer-readable medium and executing them in a processor (or controller). A computer described herein may include a single computing machine shown in FIG. 8, a virtual machine, a distributed computing system that includes multiple nodes of computing machines shown in FIG. 8, or any other suitable arrangement of computing devices.

By way of example, FIG. 8 shows a diagrammatic representation of a computing machine in the example form of a computer system 800 within which instructions 824 (e.g., software, source code, program code, expanded code, object code, assembly code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 8 may correspond to any software, hardware, or combined components shown in odor input device 110, computing device 120, data store 130, and/or olfactometer 140, such as various engines, interfaces, terminals, and machines. While FIG. 8 shows various hardware and software elements, each of the components described in FIG. 1 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 824 that specify actions to be taken by that machine. Further, while only a single machine is illustrated, the terms “machine” and “computer” may also be taken to include any collection of machines that individually or jointly execute instructions 824 to perform any one or more of the methodologies discussed herein.

The example computer system 800 includes one or more processors 802 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 800 may also include a memory 804 that stores computer code including instructions 824 that may cause the processor 802 to perform certain actions when the instructions are executed, directly or indirectly by the processor 802. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One or more methods described herein improve the operation speed of the processor 802 and reduce the space required for the memory 804. For example, the database processing techniques and machine learning methods described herein reduce the complexity of the computation of the processors 802 by applying one or more novel techniques that simplify the steps in training, reaching convergence, and generating results of the processors 802. The algorithms described herein also reduce the size of the models and datasets to reduce the storage space requirement for memory 804.

The performance of certain operations may be distributed among more than one processor, not only residing within a single machine but deployed across a number of machines. In some example embodiments, one or more processors or processor-implemented modules may be located in a single geographic location (e.g., within a home environment, an office environment, or a server farm). In other example embodiments, one or more processors or processor-implemented modules may be distributed across a number of geographic locations. Even though the specification or the claims may refer to some processes to be performed by a processor, this may be construed to include a joint operation of multiple distributed processors. In some embodiments, a computer-readable medium comprises one or more computer-readable media that, individually, together, or distributedly, comprise instructions that, when executed by one or more processors, cause the one or more processors to perform, individually, together, or distributedly, the steps of the instructions stored on the one or more computer-readable media. Similarly, a processor comprises one or more processors or processing units that, individually, together, or distributedly, perform the steps of instructions stored on a computer-readable medium. In various embodiments, the discussion of one or more processors that carry out a process with multiple steps does not require any one of the processors to carry out all of the steps. For example, a processor A can carry out step A, a processor B can carry out step B using, for example, the result from the processor A, and a processor C can carry out step C, etc. The processors may work cooperatively in this type of situation such as in multiple processors of a system in a chip, in Cloud computing, or in distributed computing.

The computer system 800 may include a main memory 804, and a static memory 806, which are configured to communicate with each other via a bus 808. The computer system 800 may further include a graphics display unit 810 (e.g., a plasma display panel (PDP), a liquid crystal display (LCD), a projector, or a cathode ray tube (CRT)). The graphics display unit 810, controlled by the processor 802, displays a graphical user interface (GUI) to display one or more results and data generated by the processes described herein. The computer system 800 may also include an alphanumeric input device 812 (e.g., a keyboard), a cursor control device 814 (e.g., a mouse, a trackball, a joystick, a motion sensor, or other pointing instruments), a storage unit 816 (a hard drive, a solid-state drive, a hybrid drive, a memory disk, etc.), a signal generation device 818 (e.g., a speaker), and a network interface device 820, which also are configured to communicate via the bus 808.

The storage unit 816 includes a computer-readable medium 822 on which is stored instructions 824 embodying any one or more of the methodologies or functions described herein. The instructions 824 may also reside, completely or at least partially, within the main memory 804 or within the processor 802 (e.g., within a processor's cache memory) during execution thereof by the computer system 800, the main memory 804 and the processor 802 also constituting computer-readable media. The instructions 824 may be transmitted or received over a network 826 via the network interface device 820.

While computer-readable medium 822 is shown in an example embodiment to be a single medium, the term “computer-readable medium” should be taken to include a single medium or multiple media (e.g., a centralized or distributed database, or associated caches and servers) able to store instructions (e.g., instructions 824). The computer-readable medium may include any medium that is capable of storing instructions (e.g., instructions 824) for execution by the processors (e.g., processors 802) and that causes the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### Example Embodiments

Embodiment 1. A system for altering an odor, the system comprising: a computing device comprising memory and one or more processors, the memory configured to store code comprising instructions, wherein the instructions, when executed by the one or more processors, cause the one or more processors to: receive a characterization of a source odor, the characterization determined according to a set of odor characteristics; initiate an odor gamut that is defined by a plurality of primary odors, each primary odor defined by one or more component compounds; and determine a target release mixture of the primary odors that alters the source odor to a target odor, wherein the target release mixture superimposes with the source odor in the odor gamut to generate the target odor; and an olfactometer in communication with the computing device, the olfactometer configured to release, in an environment where the source odor is present, a chemical mixture corresponding to the target release mixture to convert the source odor to the target odor.

Embodiment 2. The system of embodiment 1, wherein the target release mixture of the primary odors is transmitted to the olfactometer as a composition of the primary odors, and the olfactometer is configured to release the chemical mixture according to the composition of the primary odors.

Embodiment 3. The system of embodiment 1 or 2, wherein the source odor corresponds to a foul smell in the environment and the olfactometer is configured to release the chemical mixture to change the foul smell to the target odor.

Embodiment 4. The system of any of embodiments 1-3, wherein the set of odor characteristics corresponding to the source odor comprises a set of intensity perceptions related to the set of odor characteristics.

Embodiment 5. The system of any of embodiments 1-4, wherein the source odor is represented by a first coordinate in the odor gamut and the target odor is represented by a second coordinate in the odor gamut, and wherein the target release mixture is determined by a vector of compositions of primary odors in which the first coordinate is added with the vector in the odor gamut to generate the second coordinate.

Embodiment 6. The system of any of embodiments 1-5, wherein the characterization of the source odor is received from an odor input device that receives an input of the set of odor characteristics by a user in the environment.

Embodiment 7. The system of any of embodiments 1-6, wherein the set of odor characteristics is represented by a vector of a composition of the plurality of primary odors.

Embodiment 8. The system of any of embodiments 1-7, wherein the odor gamut is in an N-dimensional space that is defined by N primary odors, and N is equal to or greater than 5.

Embodiment 9. The system of any of embodiments 1-7, wherein the odor gamut is an N-dimension gamut that is defined by N primary odors, and N is equal to or greater than 10.

Embodiment 10. The system of any of embodiments 1-9, wherein the olfactometer comprises a set of receptacles, and each receptacle is configured to a mixture of one or more chemicals that are mixed to generate one of the primary odors.

Embodiment 11. The system of embodiment 10, wherein the olfactometer comprises a set of controls, and each control corresponds to one of the receptacles and is configured to control a release of one of the primary odors.

Embodiment 12. The system of embodiment 11, wherein the chemical mixture corresponding to the target release mixture is generated by controlling the set of controls to regulate a composition of the primary odors.

Embodiment 13. The system of embodiments 11 or 12, wherein the primary odors in the chemical mixture correspond to the target release mixture is controlled by volume, pressure, or concentration.

Embodiment 14. The system of any of embodiments 1-13, wherein the set of odor characteristics is selected from one or more odor characteristics from Table 1.

Embodiment 15. The system of any of embodiments 1-14, further comprising a storage medium configured to store a digital representation of the source odor, the digital representation being a vector of primary odors.

Embodiment 16. A computer-implemented method for altering an odor, the computer-implemented method comprising: receiving a characterization of a source odor, the characterization determined according to a set of odor characteristics; initiating an odor gamut that is defined by a plurality of primary odors, each primary odor defined by one or more component compounds; determining a target release mixture of the primary odors that alters the source odor to a target odor, wherein the target release mixture superimposes with the source odor in the odor gamut to generate the target odor; and transmitting the target release mixture to an olfactometer to cause the olfactometer to release, in an environment where the source odor is present, a chemical mixture corresponding to the target release mixture to convert the source odor to the target odor.

Embodiment 17. The computer-implemented method of embodiment 16, wherein receiving the characterization of the source odor comprises: causing an odor input device to display a user interface that allows a user to input a scale for each of the set of odor characteristics; receiving an input of the user inputting the set of odor characteristics; and transforming the set of odor characteristics to a vector of the primary odors.

Embodiment 18. The computer-implemented method of embodiment 16, wherein receiving the characterization of the source odor comprises: receiving, from a user, an indication of foul smell in the environment; causing an odor input device to display a list of foul smell candidates; receiving a selection of a foul smell candidate from the user as the source odor; and storing a predefined set of odor characteristics as the characterization of the source odor.

Embodiment 19. The computer-implemented method of any of embodiments 16-18, wherein initiating the odor gamut that is defined by the plurality of primary odors comprises: selecting N primary odors, wherein N is equal to or greater than 5; defining an N-dimensional space that is defined by the N primary odors; and representing the source odor and the target odor as vectors in the N-dimensional space.

Embodiment 20. The computer-implemented method of any of embodiments 16-19, wherein initiating the odor gamut that is defined by the plurality of primary odors comprises:

identifying a first subset of primary odors that are used to generate the source odor; identifying a second subset of primary odors that are used to generate the target odor; determining a union set of primary odors that is a union of the first and second subsets of primary odors; and using the union set of primary odors to generate the odor gamut.

Embodiment 21. The computer-implemented method of any of embodiments 16-20, wherein determining the target release mixture of the primary odors that alters the source odor to the target odor comprises: generating a first coordinate in the odor gamut to represent the source odor; generating a second coordinate in the odor gamut to represent the target odor; determining a vector of compositions of primary odors in which the first coordinate is added with the vector in the odor gamut to generate the second coordinate; and determining the target release mixture using the vector of compositions of primary odors.

Embodiment 22. The computer-implemented method of any of embodiments 16-20, wherein determining the target release mixture of the primary odors that alters the source odor to the target odor comprises: generating a first coordinate in the odor gamut to represent the source odor; generating an opposite vector that removes one or more odor characteristics of the source odor represented by the first coordinate; and generating the target release mixture based on the opposite vector, the target release mixture is projected to neutralize the source odor.

Embodiment 23. The computer-implemented method of any of embodiments 16-22, wherein causing the olfactometer to release the chemical mixture comprises controlling a set of controls of the olfactometer to regulate a composition of the primary odors.

Embodiment 24. The computer-implemented method of embodiment 23, wherein the primary odors in the chemical mixture corresponding to the target release mixture are controlled by volume, pressure, or concentration.

Embodiment 25. The computer-implemented method of any of embodiments 16-24, further comprising storing a digital representation of the source odor in a storage medium, wherein the digital representation being a vector of primary odors.

Embodiment 26. A portable olfactometer, comprising: a plurality of receptacles configured to store chemicals that are used to produce one or more odors; a plurality of controls configured to control release of the chemicals stored in the plurality of receptacles; and a controller in communication with the plurality of controls, the controller configured to: receive a digital representation of a target odor, wherein the digital representation representing the target odor that is quantified based on a combination of primary odors in an odor gamut, and generate commands to one or more controls to release a target composition of the chemicals to generate the target odor.

Embodiment 27. The portable olfactometer of embodiment 26, wherein the portable olfactometer is capable of creating more than 100 different odors that are quantified in the odor gamut.

Embodiment 28. The portable olfactometer of embodiment 26 or claim 27, wherein the plurality of receptacles are configured to store at least five chemicals.

Embodiment 29. The portable olfactometer of any of embodiments 26-28, wherein the plurality of receptacles are configured to store at least ten chemicals.

Embodiment 30. The portable olfactometer of any of embodiments 26-29, wherein one of the chemicals corresponds to one of the primary odors in the odor gamut.

Embodiment 31. The portable olfactometer of any of embodiments 26-30, further comprising a wireless interface configured to receive the digital representation from a remote device.

Embodiment 32. The portable olfactometer of any of embodiments 26-31, wherein the portable olfactometer is part of an entertainment system.

Embodiment 33. A controller of an olfactometer, the controller configured to be in communication with memory configured to store code comprising instructions, wherein the instructions, when executed by the controller, cause the controller to: store a plurality of digital representations of odors, each digital representation being defined by an odor gamut that is defined by a plurality of primary odors, each primary odor defined by one or more component compounds, the plurality of digital representations representing a spectrum of odors that are within the odor gamut; receive a request to generate a target odor; determine a digital representation of the target odor, wherein the digital representation of the target odor is representable by a composition of the component compounds; and transmit a command of the composition of the component compounds to the olfactometer to release the target odor.

Embodiment 34. The controller of embodiment 33, wherein the controller is located within part of a housing of the olfactometer.

Embodiment 35. The controller of embodiment 33 or claim 34, wherein the controller is remote from the olfactometer.

Embodiment 36. The controller of any of embodiments 33-35, wherein at least one of the digital representations is a combination of the plurality of primary odors.

Embodiment 37. The controller of any of embodiments 33-36, wherein the spectrum of odors comprises at least 50 different odors that are defined by the odor gamut.

Embodiment 38. The controller of any of embodiments 33-37, wherein the spectrum of odors comprises at least 100 different odors that are defined by the odor gamut.

Embodiment 39. The controller of any of embodiments 33-38, wherein the at least one of the odors in the spectrum of odors are inputted by an end user characterizing the odor.

Embodiment 40. A non-transitory computer-readable medium configured to store code comprising instructions, wherein the instructions, when executed by one or more processors, cause the one or more processors to: receive a reporting of an odor from a user; cause an input device to display an interface for the user to enter a set of odor characteristics of the odor; convert the set of odor characteristics as a digital representation of the odor; and store the digital representation of the odor in a data store such that the odor is reproducible by using a combination of primary odors that define an odor gamut.

Embodiment 41. The non-transitory computer-readable medium of embodiment 40, wherein the data store is configured to store a plurality of digital representations of odors that are generated from a plurality of users.

Embodiment 42. The non-transitory computer-readable medium of embodiment 40 or claim 41, wherein the plurality of digital representations are transferrable to an odor research institute for reproduction of the odors.

Embodiment 43. The non-transitory computer-readable medium of any of embodiments 40-42, wherein a reproduced odor that is reproduced by the digital representation has a different chemical composition of the odor reported by the user.

Embodiment 44. The non-transitory computer-readable medium of any of embodiments 40-43, wherein the digital representation is a combination of the plurality of primary odors.

Embodiment 45. The non-transitory computer-readable medium of any of embodiments 40-44, wherein the digital representation is stored with a user identifier corresponding to the user.

Embodiment 46. A system for reproducing an odor, the system comprising: an odor input device configured to input a set of odor characteristics of the odor, an odor characteristic in the set being a perception of intensity of the odor characteristic; a computing device configured to convert the set of odor characteristics to a vector of primary odors, the vector of primary odors defining the odor in an odor gamut; a storage device comprising memory configured to store the vector of primary odors as a digital representation of the odor; and an olfactometer comprising a plurality of receptacles, wherein each of the receptacles is configured to store one of the primary odors, and wherein the olfactometer is configured to receive the vector and reproduce the odor using a composition of the primary odors determined based on the vector that corresponds to the digital representation of the odor.

Embodiment 47. The system of embodiment 46, wherein the olfactometer further comprises a set of controls, and each control corresponds to one of the receptacles and is configured to control a release of one of the primary odors based on the composition of the primary odors.

Embodiment 48. The system of embodiment 47, wherein the composition of the primary odors is controlled by volume, pressure, or concentration.

Embodiment 49. The system of any of embodiments 46-48, wherein the vector of primary odors as the digital representation of the odor is transmitted to a plurality of olfactometers to reproduce the odor in a plurality of environments.

Embodiment 50. The system of any of embodiments 46-49, wherein each of the primary odors corresponds to a mix of one or more chemical compounds that generate said each of the primary odors.

Embodiment 51. The system of embodiment 50, wherein the one or more chemical compounds are naturally occurring aroma compounds.

Embodiment 52. The system of any of embodiments 46-51, wherein the set of odor characteristics is selected from one or more odor characteristics from Table 1

Embodiment 53. The system of any of embodiments 46-52, wherein the odor gamut is in an N-dimensional space that is defined by N primary odors, and N is equal to or greater than 5.

Embodiment 54. The system of any of embodiments 46-52, wherein the odor gamut is in an N-dimensional space that is defined by N primary odors, and N is equal to or greater than 10.

Embodiment 55. A computer-implemented method for reproducing an odor, the computer-implemented method comprising: receiving a set of odor characteristics of the odor, an odor characteristic in the set being a perception of intensity of the odor characteristic; converting the set of odor characteristics to a vector of primary odors, the vector of primary odors defining the odor in an odor gamut; storing the vector of primary odors as a digital representation of the odor; transmitting the vector to an olfactometer, the olfactometer comprising a plurality of receptacles, each of the receptacles configured to store one of the primary odors; and causing an olfactometer to reproduce the odor using a composition of the primary odors determined based on the vector that corresponds to the digital representation of the odor.

Embodiment 56. The computer-implemented method of embodiment 55, wherein receiving the set of odor characteristics of the odor comprises: causing an odor input device to display a user interface that allows a user to input a scale for each of the set of odor characteristics; receiving an input of the user inputting the set of odor characteristics, the input comprising the scale for each of the set of odor characteristics; and associating the odor with a user identifier corresponding to the user.

Embodiment 57. The computer-implemented method of embodiment 56, wherein the olfactometer is caused to reproduce the odor in an environment at which the user is located.

Embodiment 58. The computer-implemented method of any of embodiments 55-57, wherein converting the set of odor characteristics to the vector of primary odors comprises: selecting N primary odors, wherein N is equal to or greater than 5; defining an N-dimensional space that is defined by the N primary odors, the N-dimensional space being the odor gamut; and representing the odor as the vector in the N-dimensional space.

Embodiment 59. The computer-implemented method of any of embodiments 55-58, wherein the olfactometer further comprises a set of controls, and each control corresponds to one of the receptacles and is configured to control a release of one of the primary odors based on the composition of the primary odors.

Embodiment 60. The computer-implemented method of any of embodiments 55-59, wherein each of the primary odors corresponds to a mix of one or more chemical compounds that generate said each of the primary odors.

Embodiment 61. An apparatus for generating a target aroma, the apparatus comprising: a means for inputting a digital representation of the target aroma into a control module, wherein the digital representation is a numerical vector, and each value of the vector corresponds to the perception of intensity of an odor characteristic selected from the following: i. Green ii. Cucumber iii. Herbal iv. Mint v. Woody vi. Pine vii. Floral viii. Powdery ix. Fruity x. Citrus xi. Tropical xii. Berry xiii. Peach xiv. Sweet xv. Caramellic xvi. Vanilla xvii. brown spice xviii. smoky xix. burnt xx. roasted xxi. grainy xxii. meaty xxiii. nutty xxiv. fatty xxv. coconut xxvi. waxy xxvii. dairy xxviii. buttery xxix. cheesy xxx. animal xxxi. sulfurous xxxii. onion/garlic xxxiii. earthy xxxiv. mushroom xxxv. musty xxxvi. medicinal xxxvii. phenolic xxxviii. cooling xxxix. sharp xl. chlorine xli. alcoholic xlii. plastic xliii. rubber xliv. fermented xlv. sour xlvi. rotten/decay xlvii. fecal xlviii. ammonia xlix. fishy 1. ozone 1i. metallic, a set of primary odor sources, each comprising a container for storing a single odor from the set of primary odors; a device selected from the group consisting of dispersers and collectors; pumping means associated with each of said odor sources for drawing odor source material therefrom and delivering the drawn odor source material to said device; and the control means comprising a model trained to generate a formula for the subject aroma from a combination of two or more odors from a set of primary odors and being responsive to said means for inputting a digital representation of said target aroma for selecting and operating said pumping means; whereby a combination of primary odor source materials from said primary odor sources, selected by the control module based on the generated formula, and corresponding to the numerical vector, is delivered by said pumping means to said device.

Embodiment 62. The apparatus of embodiment 61, comprising both a collector and a disperser.

Embodiment 63. The apparatus of embodiment 61 or claim 62, wherein the model is trained using sets of combinations of odors, each set comprising component odor A, component odor A′, and combination odor A which is formed from component odor A and component odor A′, wherein the perceptual vector for each component odor A, component odor A′, and combination odor A are defined, and are input into a computer, wherein multiple sets of combinations of odors are input into a computer, wherein the resultant model predicts olfactory properties of combinations of two or more odors.

Embodiment 64. A method for generating a subject aroma using the apparatus of embodiments 61-63, the method comprising: providing to the apparatus of any one of claims 61-63 the vector of the subject aroma; wherein the apparatus control means generates a formula for the subject aroma, wherein the formula comprises a specific amount of each of the two or more odors from the primary set of odors; and wherein the formula corresponding to the vector is generated.

Embodiment 65. The method of embodiment 64, wherein the aroma is further dispersed.

Embodiment 66. The method of any one of embodiments 61 to 65, wherein the model predicts the component odors from the primary set of odors that can be combined into the subject aroma.

Embodiment 67. The apparatus of embodiment 61, wherein each value of the vector ranges from 0-5 inclusive.

Embodiment 68. The apparatus of embodiment 61, wherein the vector comprises at least 5 values.

Embodiment 69. The apparatus of embodiment 61, wherein the vector comprises at least 10 values.

Embodiment 70. The apparatus of embodiment 61, wherein the vector comprises at least 25 values.

Embodiment 71. The apparatus of embodiment 61, wherein the vector comprises at least 50 values.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g., method, can be claimed in another claim category, e.g., computer program product, system, or storage medium, as well. The dependencies or references in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcodes, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limited, of the scope of the patent rights.

1. A system for altering an odor, the system comprising:
a computing device comprising memory and one or more processors, the memory configured to store code comprising instructions, wherein the instructions, when executed by the one or more processors, cause the one or more processors to:
receive a characterization of a source odor, the characterization determined according to a set of odor characteristics;
initiate an odor gamut that is defined by a plurality of primary odors, each primary odor defined by one or more component compounds; and
determine a target release mixture of the primary odors that alters the source odor to a target odor, wherein the target release mixture superimposes with the source odor in the odor gamut to generate the target odor; and
an olfactometer in communication with the computing device, the olfactometer configured to release, in an environment where the source odor is present, a chemical mixture corresponding to the target release mixture to convert the source odor to the target odor.

2. The system of claim 1, wherein the target release mixture of the primary odors is transmitted to the olfactometer as a composition of the primary odors, and the olfactometer is configured to release the chemical mixture according to the composition of the primary odors.

3. The system of claim 1, wherein the source odor corresponds to a foul smell in the environment and the olfactometer is configured to release the chemical mixture to change the foul smell to the target odor.

4. The system of claim 1, wherein the set of odor characteristics corresponding to the source odor comprises a set of intensity perceptions related to the set of odor characteristics.

5. The system of claim 1, wherein the source odor is represented by a first coordinate in the odor gamut and the target odor is represented by a second coordinate in the odor gamut, and wherein the target release mixture is determined by a vector of compositions of primary odors in which the first coordinate is added with the vector in the odor gamut to generate the second coordinate.

6. The system of claim 1, wherein the characterization of the source odor is received from an odor input device that receives an input of the set of odor characteristics by a user in the environment.

7. The system of claim 1, wherein the set of odor characteristics is represented by a vector of a composition of the plurality of primary odors.

8. The system of claim 1, wherein the odor gamut is in an N-dimensional space that is defined by N primary odors, and N is equal to or greater than 5.

9. The system of claim 1, wherein the odor gamut is an N-dimension gamut that is defined by N primary odors, and N is equal to or greater than 10.

10. The system of claim 1, wherein the olfactometer comprises a set of receptacles, and each receptacle is configured to a mixture of one or more chemicals that are mixed to generate one of the primary odors.

11. The system of claim 10, wherein the olfactometer comprises a set of controls, and each control corresponds to one of the receptacles and is configured to control a release of one of the primary odors.

12. The system of claim 11, wherein the chemical mixture corresponding to the target release mixture is generated by controlling the set of controls to regulate a composition of the primary odors.

13. The system of claim 11, wherein the primary odors in the chemical mixture correspond to the target release mixture is controlled by volume, pressure, or concentration.

14. The system of claim 1, wherein the set of odor characteristics is selected from one or more odor characteristics from Table 1.

15. The system of claim 1, further comprising a storage medium configured to store a digital representation of the source odor, the digital representation being a vector of primary odors.

16. A computer-implemented method for altering an odor, the computer-implemented method comprising:
receiving a characterization of a source odor, the characterization determined according to a set of odor characteristics;
initiating an odor gamut that is defined by a plurality of primary odors, each primary odor defined by one or more component compounds;
determining a target release mixture of the primary odors that alters the source odor to a target odor, wherein the target release mixture superimposes with the source odor in the odor gamut to generate the target odor; and
transmitting the target release mixture to an olfactometer to cause the olfactometer to release, in an environment where the source odor is present, a chemical mixture corresponding to the target release mixture to convert the source odor to the target odor.

17. The computer-implemented method of claim 16, wherein receiving the characterization of the source odor comprises:
causing an odor input device to display a user interface that allows a user to input a scale for each of the set of odor characteristics;
receiving an input of the user inputting the set of odor characteristics; and
transforming the set of odor characteristics to a vector of the primary odors.

18. The computer-implemented method of claim 16, wherein receiving the characterization of the source odor comprises:
receiving, from a user, an indication of foul smell in the environment;
causing an odor input device to display a list of foul smell candidates;
receiving a selection of a foul smell candidate from the user as the source odor; and
storing a predefined set of odor characteristics as the characterization of the source odor.

19. The computer-implemented method of claim 16, wherein initiating the odor gamut that is defined by the plurality of primary odors comprises:
selecting N primary odors, wherein N is equal to or greater than 5;
defining an N-dimensional space that is defined by the N primary odors; and
representing the source odor and the target odor as vectors in the N-dimensional space.

20. The computer-implemented method of claim 16, wherein initiating the odor gamut that is defined by the plurality of primary odors comprises:
identifying a first subset of primary odors that are used to generate the source odor;
identifying a second subset of primary odors that are used to generate the target odor;
determining a union set of primary odors that is a union of the first and second subsets of primary odors; and
using the union set of primary odors to generate the odor gamut.

21. The computer-implemented method of claim 16, wherein determining the target release mixture of the primary odors that alters the source odor to the target odor comprises:
generating a first coordinate in the odor gamut to represent the source odor;
generating a second coordinate in the odor gamut to represent the target odor;
determining a vector of compositions of primary odors in which the first coordinate is added with the vector in the odor gamut to generate the second coordinate; and
determining the target release mixture using the vector of compositions of primary odors.

22. The computer-implemented method of claim 16, wherein determining the target release mixture of the primary odors that alters the source odor to the target odor comprises:
generating a first coordinate in the odor gamut to represent the source odor;
generating an opposite vector that removes one or more odor characteristics of the source odor represented by the first coordinate; and
generating the target release mixture based on the opposite vector, the target release mixture is projected to neutralize the source odor.

23. The computer-implemented method of claim 16, wherein causing the olfactometer to release the chemical mixture comprises controlling a set of controls of the olfactometer to regulate a composition of the primary odors.

24. The computer-implemented method of claim 23, wherein the primary odors in the chemical mixture corresponding to the target release mixture are controlled by volume, pressure, or concentration.

25. The computer-implemented method of claim 16, further comprising storing a digital representation of the source odor in a storage medium, wherein the digital representation being a vector of primary odors.

26. A portable olfactometer, comprising:
a plurality of receptacles configured to store chemicals that are used to produce one or more odors;
a plurality of controls configured to control release of the chemicals stored in the plurality of receptacles; and
a controller in communication with the plurality of controls, the controller configured to:
receive a digital representation of a target odor, wherein the digital representation representing the target odor that is quantified based on a combination of primary odors in an odor gamut, and
generate commands to one or more controls to release a target composition of the chemicals to generate the target odor.

27. The portable olfactometer of claim 26, wherein the portable olfactometer is capable of creating more than 100 different odors that are quantified in the odor gamut.

28. The portable olfactometer of claim 26, wherein the plurality of receptacles are configured to store at least five chemicals.

29. The portable olfactometer of claim 26, wherein the plurality of receptacles are configured to store at least ten chemicals.

30. The portable olfactometer of claim 26, wherein one of the chemicals corresponds to one of the primary odors in the odor gamut.

31. The portable olfactometer of claim 26, further comprising a wireless interface configured to receive the digital representation from a remote device.

32. The portable olfactometer of claim 26, wherein the portable olfactometer is part of an entertainment system.

33. A controller of an olfactometer, the controller configured to be in communication with memory configured to store code comprising instructions, wherein the instructions, when executed by the controller, cause the controller to:
store a plurality of digital representations of odors, each digital representation being defined by an odor gamut that is defined by a plurality of primary odors, each primary odor defined by one or more component compounds, the plurality of digital representations representing a spectrum of odors that are within the odor gamut;
receive a request to generate a target odor;
determine a digital representation of the target odor, wherein the digital representation of the target odor is representable by a composition of the component compounds; and
transmit a command of the composition of the component compounds to the olfactometer to release the target odor.

34. The controller of claim 33, wherein the controller is located within part of a housing of the olfactometer.

35. The controller of claim 33, wherein the controller is remote from the olfactometer.

36. The controller of claim 33, wherein at least one of the digital representations is a combination of the plurality of primary odors.

37. The controller of claim 33, wherein the spectrum of odors comprises at least 50 different odors that are defined by the odor gamut.

38. The controller of claim 33, wherein the spectrum of odors comprises at least 100 different odors that are defined by the odor gamut.

39. The controller of claim 33, wherein the at least one of the odors in the spectrum of odors are inputted by an end user characterizing the odor.

40. A non-transitory computer-readable medium configured to store code comprising instructions, wherein the instructions, when executed by one or more processors, cause the one or more processors to:
receive a reporting of an odor from a user;
cause an input device to display an interface for the user to enter a set of odor characteristics of the odor;
convert the set of odor characteristics as a digital representation of the odor; and
store the digital representation of the odor in a data store such that the odor is reproducible by using a combination of primary odors that define an odor gamut.

41. The non-transitory computer-readable medium of claim 40, wherein the data store is configured to store a plurality of digital representations of odors that are generated from a plurality of users.

42. The non-transitory computer-readable medium of claim 40, wherein the plurality of digital representations are transferrable to an odor research institute for reproduction of the odors.

43. The non-transitory computer-readable medium of claim 40, wherein a reproduced odor that is reproduced by the digital representation has a different chemical composition of the odor reported by the user.

44. The non-transitory computer-readable medium of claim 40, wherein the digital representation is a combination of the plurality of primary odors.

45. The non-transitory computer-readable medium of claim 40, wherein the digital representation is stored with a user identifier corresponding to the user.

46. A system for reproducing an odor, the system comprising:
an odor input device configured to input a set of odor characteristics of the odor, an odor characteristic in the set being a perception of intensity of the odor characteristic;
a computing device configured to convert the set of odor characteristics to a vector of primary odors, the vector of primary odors defining the odor in an odor gamut;
a storage device comprising memory configured to store the vector of primary odors as a digital representation of the odor; and
an olfactometer comprising a plurality of receptacles, wherein each of the receptacles is configured to store one of the primary odors, and wherein the olfactometer is configured to receive the vector and reproduce the odor using a composition of the primary odors determined based on the vector that corresponds to the digital representation of the odor.

47. The system of claim 46, wherein the olfactometer further comprises a set of controls, and each control corresponds to one of the receptacles and is configured to control a release of one of the primary odors based on the composition of the primary odors.

48. The system of claim 47, wherein the composition of the primary odors is controlled by volume, pressure, or concentration.

49. The system of claim 46, wherein the vector of primary odors as the digital representation of the odor is transmitted to a plurality of olfactometers to reproduce the odor in a plurality of environments.

50. The system of claim 46, wherein each of the primary odors corresponds to a mix of one or more chemical compounds that generate said each of the primary odors.

51. The system of claim 50, wherein the one or more chemical compounds are naturally occurring aroma compounds.

52. The system of claim 46, wherein the set of odor characteristics is selected from one or more odor characteristics from Table 1.

53. The system of claim 46, wherein the odor gamut is in an N-dimensional space that is defined by N primary odors, and N is equal to or greater than 5.

54. The system of claim 46, wherein the odor gamut is in an N-dimensional space that is defined by N primary odors, and N is equal to or greater than 10.

55. A computer-implemented method for reproducing an odor, the computer-implemented method comprising:
receiving a set of odor characteristics of the odor, an odor characteristic in the set being a perception of intensity of the odor characteristic;
converting the set of odor characteristics to a vector of primary odors, the vector of primary odors defining the odor in an odor gamut;
storing the vector of primary odors as a digital representation of the odor;
transmitting the vector to an olfactometer, the olfactometer comprising a plurality of receptacles, each of the receptacles configured to store one of the primary odors; and
causing an olfactometer to reproduce the odor using a composition of the primary odors determined based on the vector that corresponds to the digital representation of the odor.

56. The computer-implemented method of claim 55, wherein receiving the set of odor characteristics of the odor comprises:
causing an odor input device to display a user interface that allows a user to input a scale for each of the set of odor characteristics;
receiving an input of the user inputting the set of odor characteristics, the input comprising the scale for each of the set of odor characteristics; and
associating the odor with a user identifier corresponding to the user.

57. The computer-implemented method of claim 56, wherein the olfactometer is caused to reproduce the odor in an environment at which the user is located.

58. The computer-implemented method of claim 55, wherein converting the set of odor characteristics to the vector of primary odors comprises:
selecting N primary odors, wherein N is equal to or greater than 5;
defining an N-dimensional space that is defined by the N primary odors, the N-dimensional space being the odor gamut; and
representing the odor as the vector in the N-dimensional space.

59. The computer-implemented method of claim 55, wherein the olfactometer further comprises a set of controls, and each control corresponds to one of the receptacles and is configured to control a release of one of the primary odors based on the composition of the primary odors.

60. The computer-implemented method of claim 55, wherein each of the primary odors corresponds to a mix of one or more chemical compounds that generate said each of the primary odors.

61. An apparatus for generating a target aroma, the apparatus comprising:
a means for inputting a digital representation of the target aroma into a control module, wherein the digital representation is a numerical vector, and each value of the vector corresponds to the perception of intensity of an odor characteristic selected from the following:
i. Green
ii. Cucumber
iii. Herbal
iv. Mint
v. Woody
vi. Pine
vii. Floral
viii. Powdery
ix. Fruity
x. Citrus
xi. Tropical
xii. Berry
xiii. Peach
xiv. Sweet
XV. Caramellic
xvi. Vanilla
xvii. brown spice
xviii. smoky
xix. burnt
xx. roasted
xxi. grainy
xxii. meaty
xxiii. nutty
xxiv. fatty
xxv. coconut
xxvi. waxy
xxvii. dairy
xxviii. buttery
xxix. cheesy
XXX. animal
xxxi. sulfurous
xxxii. onion/garlic
xxxiii. earthy
xxxiv. mushroom
XXXV. musty
xxxvi. medicinal
xxxvii. phenolic
xxxviii. cooling
xxxix. sharp
xl. chlorine
xli. alcoholic
xlii. plastic
xliii. rubber
xliv. fermented
xlv. sour
xlvi. rotten/decay
xlvii. fecal
xlviii. ammonia
xlix. fishy
l. ozone
li. metallic,
a set of primary odor sources, each comprising a container for storing a single odor from the set of primary odors;
a device selected from the group consisting of dispersers and collectors;
pumping means associated with each of said odor sources for drawing odor source material therefrom and delivering the drawn odor source material to said device; and
the control means comprising a model trained to generate a formula for the subject aroma from a combination of two or more odors from a set of primary odors and being responsive to said means for inputting a digital representation of said target aroma for selecting and operating said pumping means;
whereby a combination of primary odor source materials from said primary odor sources, selected by the control module based on the generated formula, and corresponding to the numerical vector, is delivered by said pumping means to said device.

62. The apparatus of claim 61, comprising both a collector and a disperser.

63. The apparatus of claim 61, wherein the model is trained
using sets of combinations of odors, each set comprising component odor A, component odor A′, and combination odor A which is formed from component odor A and component odor A′, wherein the perceptual vector for each component odor A, component odor A′, and combination odor A are defined, and are input into a computer,
wherein multiple sets of combinations of odors are input into a computer,
wherein the resultant model predicts olfactory properties of combinations of two or more odors.

64. A method for generating a subject aroma using the apparatus of claim 61, the method comprising:
providing to the apparatus of any one of claims 61-63 the vector of the subject aroma; wherein the apparatus control means generates a formula for the subject aroma, wherein the formula comprises a specific amount of each of the two or more odors from
the primary set of odors;
and wherein the formula corresponding to the vector is generated.

65. The method of claim 64, wherein the aroma is further dispersed.

66. The method of claim 61, wherein the model predicts the component odors from the primary set of odors that can be combined into the subject aroma.
